(19) United States
(12) Patent Application Publication
(10) Pub. No.: US 2012/0282458 A1
(43) Pub. Date: Nov. 8, 2012

(54) WATER-REPELLENT SUBSTRATE AND PROCESS FOR ITS PRODUCTION

(75) Inventors: Yosuke Takeda, Tokyo (JP); Noriko Kishikawa, Tokyo (JP); Takashige Yoneda, Tokyo (JP)

(73) Assignee: Asahi Glass Company, Limited, Tokyo (JP)

(21) Appl. No.: 13/546,423

(22) Filed: Jul. 11, 2012

Related U.S. Application Data
(63) Continuation of application No. PCT/JP11/50777, filed on Jan. 18, 2011.

(30) Foreign Application Priority Data
Jan. 19, 2010 (JP) 2010-008738

(51) Int. Cl. B32B 5/16; B05D 5/00; C09K 3/18; B05D 1/38

(52) U.S. Cl. 428/331; 427/379; 106/2

(57) ABSTRACT

A water-repellent substrate having a water-repellent coating film on at least one side of a substrate, wherein the water-repellent coating film comprises an undercoat layer which comprises aggregates of metal oxide fine particles having an average primary particle size of from 20 to 85 nm and a metal oxide binder, and which has a concave-convex surface, formed on the substrate side, and a water-repellent layer formed on the undercoat layer along the concave-convex structure on the surface of the undercoat layer, the water splash property as an index of the water-repellency of the surface of the water-repellent coating film is at least 100 mm, and the water splash property of the surface of the water-repellent coating film is at least 20 mm after an abrasion test for 2,000 reciprocations by means of a traverse tester at a stress of 11.8 N/4 cm² using a flannel cloth in accordance with JISL0803.

### TECHNICAL FIELD

The present invention relates to a water-repellent substrate having a water-repellent coating film excellent in the water-repellency and the abrasion resistance, and a process for its production.

### BACKGROUND ART

When rainwater deposits on a window glass of a transport machine during raining, the driver's visibility tends to be poor, which may hinder the driving. Therefore, it has been attempted to impart water-repellency to the surface of a glass plate so that deposited rainwater may be readily removed. And, in recent years, various attempts to further increase the water-repellency to improve the visibility and to improve the abrasion resistance have been proposed.

For example, Patent Document 1 discloses a technique regarding an article having a water-repellent surface characterized by a concave-convex surface, comprising an inner layer (a sintered product layer of two types of metal oxide spherical fine particles differing in the particle size) and a water-repellent layer formed on its surface. Of this article, the surface water-repellency at an ordinary level is secured, but the article does not reach a high water-repellency level, and further, it is hard to say that a sufficient abrasion resistance is achieved. This is considered to be because the particle size in the inner layer forming the concave-convex is relatively large, and no binder is used for the inner layer, whereby there is a large quantity of voids and the adhesion between the particles is weak.

Further, Patent Document 2 discloses a technique regarding an article having a water-repellent layer characterized by a concave-convex surface, comprising an inner layer (a sintered product layer of two types of metal oxide spherical fine particles differing in the particle size) and a surface layer (a layer containing hydrophobic metal oxide fine particles and a metal oxide binder). The water-repellent layer of the article disclosed in Patent Document 2 is excellent in the water-repellency, but the abrasion resistance is not necessarily sufficient due to the inner layer having the same structure as in Patent Document 1.

Further, Patent Document 3 discloses a technique regarding an ultra-water-repellent substrate comprising an undercoat film having fine concave-convex and a water-repellent coating film formed thereon, characterized by water the contact angle and the falling angle of the surface of the water-repellent coating film. Of the ultra-water-repellent substrate disclosed in Patent Document 3, the fine concave-convex of the undercoat film is obtained by forming particulate concave-convex on the film at room temperature when film materials are applied to form the film, not by incorporating preliminarily prepared particles. The ultra-water-repellent substrate disclosed in Patent Document 3 is excellent in the water-repellency, however, its undercoat film is poor in the denseness due to such a distinctive method of forming the concave-convex, and no sufficient abrasion resistance can be obtained.

### PRIOR ART DOCUMENTS

### Patent Documents

Patent Document 1: JP-A-2008-119924
Patent Document 2: WO2008/072707
Patent Document 3: WO2003/039856

### DISCLOSURE OF INVENTION

### Technical Problem

It is an object of the present invention to provide a water-repellent substrate having a water-repellent coating film excellent in the water-repellency and the abrasion resistance, and a process for its production.

### Solution to Problem

The present invention provides the following water-repellent substrate, article for a transport machine equipped with a water-repellent substrate, composition for formation of undercoat layer of a water-repellent coating film which the water-repellent substrate has, and process for producing a water-repellent substrate.

[1] A water-repellent substrate having a water-repellent coating film on at least one side of a substrate, wherein:

the water-repellent coating film comprises an undercoat layer which comprises aggregates of metal oxide fine particles (A) having an average primary particle size of from 20 to 85 nm and a metal oxide binder, and which has a concave-convex surface, formed on the substrate side, and a water-repellent layer formed on the undercoat layer; and

the water splash property of the surface of the water-repellent coating film as evaluated by the following method is at least 100 mm, and the water splash property of the surface of the water-repellent coating film is at least 20 mm after an abrasion test for 2,000 reciprocations by means of a traverse tester at a stress of 11.8 N/4 cm² using a flannel cloth in accordance with JIS L0803:

water splash property: the water-repellent substrate is placed so that the surface (hereinafter referred to as the measurement surface) having the water-repellent coating film of the substrate faces upward, and that the measurement surface has a gradient of 45° relative to the horizontal plane, 20 μl of a droplet of pure water is dropped from a height of 10 cm from the measurement surface, to the measurement surface, and a distance of splash of the water which has fallen to the measurement surface, in a direction in parallel with the measurement surface, is measured and regarded as the water splash property.

[2] A water-repellent substrate having a water-repellent coating film on at least one side of a substrate, wherein:

the water-repellent coating film comprises an undercoat layer which comprises aggregates of metal oxide fine particles (A) having an average primary particle size of from 20 to 85 nm and a metal oxide binder, and which has a concave-convex surface, formed on the substrate side, and a water-repellent layer formed on the undercoat layer; and

the water splash property of the surface of the water-repellent coating film as evaluated by the following method is at least 100 mm, and the following porosity of the water-repellent coating film is at most 30%:

water splash property: the water-repellent substrate is placed so that the surface (hereinafter referred to as the measurement surface) having the water-repellent coating film of the substrate faces upward, and that the measurement surface has a gradient of 45° relative to the horizontal plane, 20 μl of a droplet of pure water is dropped from a height of 10 cm from the measurement surface, to the measurement surface, and a distance of splash of the water which has fallen to the measurement surface, in a direction in parallel with the measurement surface, is measured and regarded as the water splash property;

porosity: the ratio (%) of the area of voids in the cross section of the water-repellent coating film.

[3] The water-repellent substrate according to [1] or [2], wherein when the mass of the aggregates of the metal oxide fine particles (A) is (a) and the mass of the metal oxide binder is (b), their mass ratio (a):(b) is from 75:25 to 50:50, as calculated as metal oxides.
[4] The water-repellent substrate according to any one of [1] to [3], wherein the arithmetic mean roughness (Ra) of the surface of the water-repellent coating film is from 15 nm to 40 nm as measured by a scanning probe microscope (SPM) in accordance with JIS R1683 (2007).
[5] The water-repellent substrate according to any one of [1] to [4], wherein the metal oxide fine particles (A) are hollow silica fine particles.
[6] The water-repellent substrate according to any one of [1] to [5], wherein the undercoat layer further contains aggregates of metal oxide fine particles (C) having an average primary particle size of from 3 to 18 nm.
[7] The water-repellent substrate according to any one of [1] to [6], wherein the average thickness of the water-repellent coating film is from 50 to 600 nm.
[8] A water-repellent substrate having a water-repellent coating film on at least one side of a substrate, wherein:

the water-repellent coating film comprises an undercoat layer which is obtained by applying a composition for formation of undercoat layer containing aggregates of metal oxide fine particles (A) having an average primary particle size of from 20 to 85 nm and a metal oxide binder precursor, followed by drying, and which has a concave-convex surface, and a water-repellent layer formed on the undercoat layer; and

the water splash property of the surface of the water-repellent coating film as evaluated by the following method is at least 100 mm, and the water splash property of the surface of the water-repellent coating film is at least 20 mm after an abrasion test for 2,000 reciprocations by means of a traverse tester at a stress of 11.8 N/4 cm² using a flannel cloth in accordance with JIS L0803:

water splash property: the water-repellent substrate is placed so that the surface (hereinafter referred to as the measurement surface) having the water-repellent coating film of the substrate faces upward, and that the measurement surface has a gradient of 45° relative to the horizontal plane, 20 μl of a droplet of pure water is dropped from a height of 10 cm from the measurement surface, to the measurement surface, and a distance of splash of the water which has fallen to the measurement surface, in a direction in parallel with the measurement surface, is measured and regarded as the water splash property.

[9] A water-repellent substrate having a water-repellent coating film on at least one side of a substrate, wherein:

the water-repellent coating film comprises an undercoat layer which is obtained by applying a composition for formation of undercoat layer containing aggregates of metal oxide fine particles (A) having an average primary particle size of from 20 to 85 nm and a metal oxide binder precursor, followed by drying, and which has a concave-convex surface, and a water-repellent layer formed on the undercoat layer; and

the water splash property of the surface of the water-repellent coating film as evaluated by the following method is at least 100 mm, and the following porosity of the water-repellent coating film is at most 30%:

water splash property: the water-repellent substrate is placed so that the surface (hereinafter referred to as the measurement surface) having the water-repellent coating film of the substrate faces upward, and that the measurement surface has a gradient of 45° relative to the horizontal plane, 20 μl of a droplet of pure water is dropped from a height of 10 cm from the measurement surface, to the measurement surface, and a distance of splash of the water which has fallen to the measurement surface, in a direction in parallel with the measurement surface, is measured and regarded as the water splash property;

porosity: the ratio (%) of the area of voids in the cross section of the water-repellent coating film.

[10] An article for a transport machine comprising the water-repellent substrate as defined in any one of [1] to [9].
[11] A window glass for a transport machine, which is the water-repellent substrate as defined in any one of [1] to [9], wherein the substrate is a glass plate.
[12] A process for producing a water-repellent substrate having a water-repellent coating film comprising an undercoat layer and a water-repellent layer, on at least one side of a substrate, which comprises:

a step of applying, on at least one side of the substrate, a composition for formation of undercoat layer containing aggregates of metal oxide fine particles, a metal oxide binder precursor and a dispersing medium;

the aggregates of the metal oxide fine particles mainly consisting of aggregates of metal oxide fine particles (A) having an average primary particle size of from 20 to 85 nm and a volume average aggregate particle size of from 200 to 600 nm, and the composition for formation of undercoat layer containing the aggregates of the metal oxide fine particles (A) and the metal oxide binder precursor in a mass ratio of from 75:25 to 50:50 as calculated as metal oxides, or

the aggregates of the metal oxide fine particles mainly consisting of aggregates of the above metal oxide fine particles (A) and aggregates of metal oxide fine particles (C) having an average primary particle size of from 3 to 18 nm and a volume average aggregate particle size of from 3 to 30 nm in an amount of from 5 to 200 mass % of the content of the aggregates of the metal oxide fine particles (A), and the composition for formation of undercoat layer containing the aggregates of the metal oxide fine particles (A) and the metal oxide binder precursor in a mass ratio of from 75:25 to 50:50 as calculated as metal oxides, and the aggregates of the metal oxide fine particles and the metal oxide binder precursor in a mass ratio of from 90:10 to 50:50 as calculated as metal oxides;

followed by drying to form an undercoat layer which has a concave-convex surface; and

a step of applying a composition for formation of water-repellent layer containing a water-repellent agent on the surface of the undercoat layer, followed by drying to form a water-repellent layer on the surface of the undercoat layer thereby to form a water-repellent coating film having an average thickness of from 50 to 600 nm.

[13] The process for producing a water-repellent substrate according to [12], wherein the mass ratio of the aggregates of the metal oxide fine particles (A) to the meal oxide binder precursor is from 72:28 to 60:40 as calculated as metal oxides.
[14] The process for producing a water-repellent substrate according to [12] or [13], wherein the metal compound to be the metal oxide binder precursor is an alkoxysilane compound and/or a hydrolyzed condensate thereof.
[15] The process for producing a water-repellent substrate according to any one of [12] to [14], wherein the metal oxide fine particles (A) are silica fine particles.
[16] The process for producing a water-repellent substrate according to any one of [12] to [15], wherein the average primary particle size of the metal oxide fine particles (A) is from 20 to 75 nm.
[17] The process for producing a water-repellent substrate according to any one of [12] to [16], wherein the metal oxide fine particles (A) are hollow metal oxide fine particles.
[18] The process for producing a water-repellent substrate according to [17], wherein the average shell thickness of the hollow metal oxide fine particles (A) is from 1 to 10 nm.
[19] The process for producing a water-repellent substrate according to any one of [12] to [18], wherein the metal oxide fine particles (C) are silica fine particles and/or zirconia fine particles.
[20] The process for producing a water-repellent substrate according to any one of [12] to [19], which further comprises, after the step for forming the undercoat layer, a step of impregnation with a polysilazane, followed by hydrolytic condensation or pyrolysis.
[21] The process for producing a water-repellent substrate according to any one of [12] to [20], which further comprises, after the step for forming the undercoat layer, a step of applying a composition for formation of adhesion layer containing, as the main material component, at least one member selected from the group consisting of alkoxysilanes, chlorosilanes and isocyanatesilanes, and/or a partially hydrolyzed condensate thereof, on the surface of the undercoat layer to form an adhesion layer.
[22] The process for producing a water-repellent substrate according to any one of [12] to [21], wherein the water splash property of the surface of the water-repellent coating film as evaluated by the following method is at least 100 mm, and the water splash property of the surface of the water-repellent coating film is at least 20 mm after an abrasion test for 2,000 reciprocations by means of a traverse tester at a stress of 11.8 N/4 cm² using a flannel cloth in accordance with JIS L0803:

water splash property: the water-repellent substrate is placed so that the surface (hereinafter referred to as the measurement surface) having the water-repellent coating film of the substrate faces upward, and that the measurement surface has a gradient of 45° relative to the horizontal plane, 20 μl of a droplet of pure water is dropped from a height of 10 cm from the measurement surface, to the measurement surface, and a distance of splash of the water which has fallen to the measurement surface, in a direction in parallel with the measurement surface, is measured and regarded as the water splash property.

[23] The process for producing a water-repellent substrate according to any one of [12] to [21], wherein the water splash property of the surface of the water-repellent coating film as evaluated by the following method is at least 100 mm, and the following porosity of the water-repellent coating film is at most 30%:

water splash property: the water-repellent substrate is placed so that the surface (hereinafter referred to as the measurement surface) having the water-repellent coating film of the substrate faces upward, and that the measurement surface has a gradient of 45° relative to the horizontal plane, 20 μl of a droplet of pure water is dropped from a height of 10 cm from the measurement surface, to the measurement surface, and a distance of splash of the water which has fallen to the measurement surface, in a direction in parallel with the measurement surface, is measured and regarded as the water splash property;

porosity: the ratio (%) of the area of voids in the cross section of the water-repellent coating film.

[24] A composition for formation of undercoat layer, to be used for the process for producing a water-repellent substrate as defined in any one of [12] to [23], which contains a dispersing medium and contains aggregates of metal oxide fine particles (A) having an average primary particle size of from 20 to 85 nm and a volume average aggregate particle size of from 200 to 600 nm, and a metal oxide binder precursor, in a mass ratio of from 75:25 to 50:50 as calculated as metal oxides.

### Advantageous Effects of Invention

The water-repellent substrate of the present invention has a water-repellent coating film excellent in the water-repellency and the abrasion resistance on its surface, whereby the water-repellent substrate itself is also excellent in the surface water-repellency, and its excellent water-repellency can be maintained for a long period of time. Further, according to the production process of the present invention, a water-repellent coating film excellent in the water-repellency and the abrasion resistance can be formed on the substrate surface.

### BRIEF DESCRIPTION OF DRAWINGS

FIG. 1 is a view schematically illustrating a method for measuring the water splash property.

FIG. 2 is a conceptual view illustrating the cross section of a water-repellent coating film prepared to measure the porosity.

### DESCRIPTION OF EMBODIMENTS

Now, the embodiments of the present invention will be described below.

### <Water-Repellent Substrate>

The water-repellent substrate of the present invention comprises a substrate and a water-repellent coating film having the following constitution formed on at least one side of the substrate. Further, the water-repellent coating film has the following surface properties.

The water-repellent coating film is a water-repellent coating film having such a constitution comprising an undercoat layer which comprises aggregates of metal oxide fine particles (A) having an average primary particles size of from 20 to 85 nm and a metal oxide binder, and which has a concave-convex surface derived from the aggregates, formed on the substrate side, and a water-repellent layer formed on the undercoat layer.

With respect to the surface properties of the water-repellent coating film, the water splash property of the surface of the water-repellent coating film as evaluated by the following method is at least 100 mm, and the water splash property of the surface of the water-repellent coating film is at least 20 mm after an abrasion test for 2,000 reciprocations by means of a traverse tester at a stress of 11.8 N/4 cm² using a flannel cloth in accordance with JIS L0803 (hereinafter sometimes referred to as “abrasion resistance test”).

water splash property: the water-repellent substrate is placed so that the surface (hereinafter referred to as the measurement surface) having the water-repellent coating film of the substrate faces upward, and that the measurement surface has a gradient of 45° relative to the horizontal plane, 20 μl of a droplet of pure water is dropped from a height of 10 cm from the measurement surface, to the measurement surface, and a distance of splash of the water droplet which has fallen to the measurement surface, in a direction in parallel with the measurement surface, is measured and regarded as the water splash property.

The “water splash property” employed to evaluate the surface properties of the water-repellent coating film is an index to evaluate the water-repellency as described hereinafter. The values of the “water splash property” of the surface of the water-repellent coating film which the water-repellent substrate of the present invention has, that is, its initial value of at least 100 mm and its value after the abrasion resistance test of at least 20 mm, mean that the water-repellent coating film is excellent in the initial water-repellency and further maintains its water-repellency even after the abrasion resistance test.

The initial value of the water splash property of the water-repellent coating film which the water-repellent substrate of the present invention has is at least 100 mm, and is preferably at least 130 mm, more preferably at least 150 mm. Further, the water splash property after the abrasion resistance test is at least 20 mm, and is preferably at least 35 mm, more preferably at least 50 mm. If the initial value of the water splash property of the water-repellent coating film is less than 100 mm, the water splash property tends to be lowered after the abrasion resistance test, and no sufficient water splash property can be maintained. Further, if the water splash property after the abrasion resistance test is less than 20 mm, the water splash property tends to be insufficient, and the probability of the water droplets remaining on the water-repellent substrate tends to be increased, thus hindering the visibility.

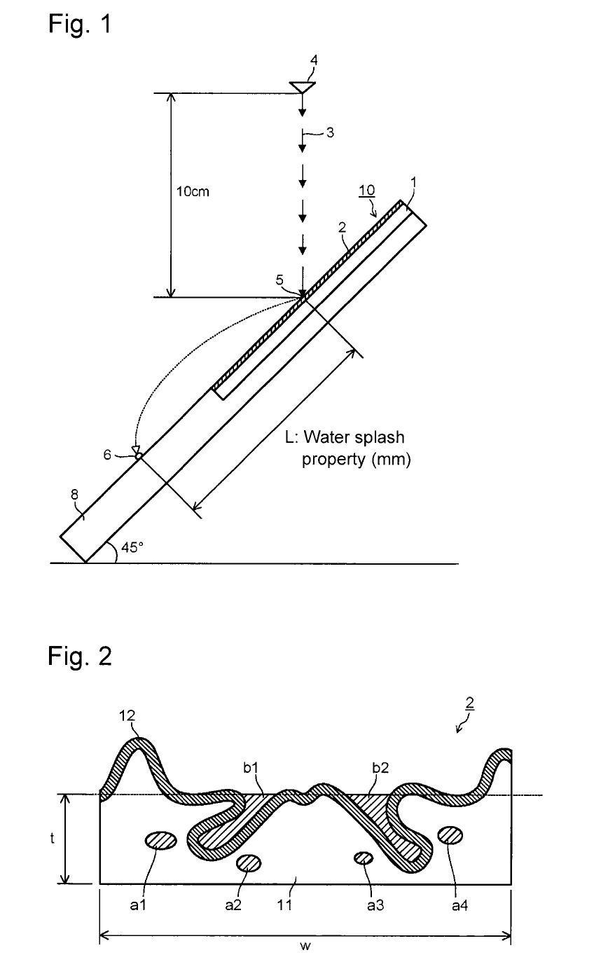

Now, the method for measuring the water splash property will be described more specifically with reference to FIG. 1.

FIG. 1 is a view schematically illustrating a measurement method to measure the water splash property on the surface of a water-repellent coating film 2 using a water-repellent substrate 10 having a water-repellent coating film 2 on one side of a substrate 1 as a specimen. As a method for measuring the “water splash property”, first, the specimen 10 is fixed to a predetermined position of a measurement stand 8 placed with a gradient of 45° relative to the horizontal plane so that the surface (measurement surface) having the water-repellent coating film 2 faces upward, whereby the measurement surface is fixed to have a gradient of 45° relative to the horizontal plane. Then, 20 μl of a droplet 3 of pure water is dropped from a dropping means 4 with a falling height of 10 cm in a direction at right angles to the horizontal plane toward a dropping point 5 substantially at the center of the measurement surface of the specimen 10. The distance L (mm) between a position 6 where the droplet 3 of pure water which has fallen from the dropping means 4 to the dropping point 5 on the measurement surface, splashes in the horizontal direction and first falls on the measurement stand 8 or the water-repellent coating film 2, and the dropping point 5, is regarded as the measured value of the “water splash property”.

Here, as evaluation of the water-repellency of the water-repellent surface, a method of employing measured values of the water contact angle and the falling angle of water as indices, and a method of connecting the degree of concave-convex on the water-repellent surface to the water-repellency to evaluate the water-repellency employing the surface roughness or the maximum peak-valley difference as indices, have been known. However, such evaluation methods do not necessarily correlate to the water-repellency required for the water-repellent substrate in actual use, particularly the water-repellency required when used e.g. as a window glass for a transport machine (for example, a window glass for a windshield of an automobile). In comparison to these methods, the above water splash property is to evaluate the water-repellent performance required for the water-repellent surface in a manner closer to the actual use, and is an evaluation method well reflecting the desired water-repellency.

The water-repellent coating film which the water-repellent substrate of the present invention has, is constituted so that the values of the “water splash property” measured by the above method before and after the abrasion resistance test are within the above ranges, and it can be regarded as a water-repellent coating film having the water-repellency and the abrasion resistance secured. Further, with respect to the water-repellent coating film which the water-repellent substrate of the present invention has, regarding the water contact angle of the surface of the water-repellent coating film, the value measured before the abrasion resistance test, i.e. the initial value is preferably at least 130°, more preferably at least 135°. Further, the water contact angle of the surface of the water-repellent coating film is preferably at least 100°, more preferably at least 110°, particularly preferably at least 120°, as a value measured after the above abrasion resistance test (abrasion test for 2,000 reciprocations by means of a traverse tester at a stress of 11.8 N/4 cm² using a flannel cloth in accordance with JIS L0803).

The above water-repellent coating film to obtain such abrasion resistance is, for example, a water-repellent coating film having a porosity as evaluated by the following method, i.e. the ratio (%) of the area of voids in the cross section of the water-repellent coating film, of at most 30%. Usually, the water-repellent coating film has water-repellency by having a concave-convex surface, although it depends on the constitution of the water-repellent coating film. However, if concave-convex is to be formed on the surface, voids are formed also in the interior of the film. If the ratio of such voids is high, the abrasion resistance cannot be secured. The water-repellent coating film having a porosity of at most 30% as specified in the present invention, can secure the sufficient abrasion resistance which meets the requirements evaluated by the water splash property.

Here, the porosity of the water-repellent coating film which the water-repellent substrate of the present invention has is at most 30%, and is preferably at most 25%, more preferably at most 20%. The porosity is particularly preferably 0%. If the porosity of the water-repellent coating film exceeds 30%, the strength of the water-repellent coating film will be reduced, and no sufficient abrasion resistance can be secured.

As a method to determine the porosity of the water-repellent coating film, for example, a method may, for example, be mentioned wherein with respect to scanning electron microscope (SEM) photograph of 500,000 magnifications at the respective cross sections obtained by cutting a 7 cm square specimen (water-repellent coating film) in a thickness direction at positions every 1 cm in one direction, the ratio of voids (the sum of closed voids present in the interior of the coating film when the cross section is projected at right angles and concave voids open to the coating film upper side (surface) present in a size of at most the average thickness of the coating film when the cross section is projected at right angles, provided that when hollow metal oxide fine particles (A) are used, the voids in the hollow fine particles is not added in to the voids of the cross section of the film) to the area of the water-repellent coating film when the cross section is projected at right angles, is obtained with respect to optional 20 points on the cut cross sections, and the obtained ratios are averaged. Further, the above “closed voids present in the interior of the coating film when the cross section is projected at right angles” includes voids which are communicated to the coating film upper side (surface) at a portion other than the cross section projected at right angles.

Now, the method for measuring “the porosity” will be described more specifically with reference to FIG. 2. FIG. 2 is a conceptual view illustrating the cross section of a water-repellent coating film prepared to measure the porosity. The water-repellent coating film 2 the cross section of which is shown in FIG. 2 comprises an undercoat layer 11 having a concave-convex surface and a water-repellent layer 12 formed on the undercoat layer 11 along the concave-convex of the undercoat layer 11, formed on a substrate (not shown). The cross section to be used for the porosity measurement is photographed by using a scanning electron microscope (SEM), for example, a scanning electron microscope (manufactured by Hitachi, Ltd., S-4500 model) with 500,000 magnifications.

The water-repellent coating film having a concave-convex surface has voids in its interior as described above. Further, according to this method for measuring the porosity, the concave portion open to the coating film upper side (surface) present in a size of at most the average thickness is regarded as voids.

The water-repellent coating film 2 shown in FIG. 2 has closed voids a1, a2, a3 and a4 present in the interior of the coating film when the cross section is projected at right angles, and has concave voids b1 and b2 open to the coating film upper side (surface) present in a size of at most the average thickness of the coating film when the cross section is projected at right angles. Accordingly, the area of voids in the cross section of the water-repellent coating film 2 shown in FIG. 2 is the sum of the areas of a1, a2, a3, a4, b1 and b2. Further, the area of the cross section of the water-repellent coating film 2 shown in FIG. 2 when the cross section is projected at right angles is calculated as the product of the average thickness t and the length w in a width direction of the cross section in a SEM photograph, measured by the following method. The porosity (%) employing these values employing the cross section of the water-repellent coating film 2 shown in FIG. 2 is calculated as

(a1+a2+a3+a4+b1+b2)/(t×w)×100.

Here, the porosity employed in this specification is an average of porosities measured and calculated in the same manner as above, from SEM photographs with respect to 20 points randomly selected from the respective cross sections obtained by cutting a 7 cm square specimen in a thickness direction at positions every 1 cm in one direction.

Further, the average thickness is measured and calculated, in the same manner as for the above porosity measurement, by using scanning electron microscope photographs (500,000 magnifications) of the cross sections of the water-repellent coating film. That is, with respect to the water-repellent coating film surface present in a width of 12.7 cm in the photograph of the cross section of the water-repellent coating film (the width of the actual water-repellent coating film is 2.54 μm), the distance from the side on the substrate surface side of the water-repellent coating film (the lower side of the water-repellent coating film) to the water-repellent coating film surface is measured to determine the average in this cross section. Such an average in the cross section is obtained with respect to 20 points of the cross sections of the water-repellent coating film prepared in the same manner as for the porosity, and their average is regarded as the average thickness.

Now, the respective constituents constituting the water-repellent substrate of the present invention will be described.

### (1) Substrate

The substrate to be used for the water-repellent substrate of the present invention is not particularly limited so long as it is a substrate made of a material for which impartment of the water-repellency is usually required, and a substrate made of glass, metal, ceramics, a resin or a combination thereof (such as a composite material or a laminated material) is preferably used. The glass may, for example, be conventional soda lime glass, borosilicate glass, alkali-free glass or quartz glass, and among them, soda lime glass is particularly preferred. The material for the resin substrate may be at least one member selected from the group consisting of a polyethylene terephthalate, a polycarbonate, a polymethyl methacrylate and a triacetylcellulose. The substrate may be transparent or opaque and may suitably be selected depending upon the particular application. For example, in a case where the water-repellent substrate of the present invention is used as a window glass (for example, a window glass for a windshield, a window glass for a side window or a window glass for a rear window of an automobile) for a transport machine such as an automobile, as a window glass for building, or as a cover for a solar cell, it is preferably a transparent glass plate.

The surface of the substrate is preferably polished with a polishing agent made of e.g. cerium oxide or degreased by means of e.g. cleaning with an alcohol, before the after-mentioned undercoat layer is formed on the substrate surface. Otherwise, oxygen plasma treatment, corona discharge treatment or ozone treatment may, for example, be applied. The shape of the substrate may be a flat plate, or may entirely or partially have a curvature. The surface of the substrate may be flat or may have a concave-convex structure. The thickness of the substrate is suitably selected depending upon the particular application and is usually preferably from 1 to 10 mm. Further, as a substrate, a resin film having a thickness of from about 25 to 500 μm may be used. The substrate may preliminarily be provided with a coating film made of an inorganic material and/or an organic material to impart at least one function selected from a hard coat, an alkali barrier, coloring, electrical conduction, prevention of static charge, light scattering, antireflection, collection of light, polarization of light, ultraviolet shielding, infrared shielding, antifouling, antifogging, photocatalyst, antibacterial, fluorescent, light storage, wavelength change, control of refractive index, water-repellency, oil repellency, removal of finger prints and lubricity.

The water-repellent substrate of the present invention may have the water-repellent coating film on each side of the substrate, or may have the water-repellent coating film on one side of the substrate, and selection may suitably be made depending upon the particular application. For example, in a case where the water-repellent substrate of the present invention is to be used for a window glass for a transport machine such as an automobile or for a window glass for building, it is preferably a glass plate having a water-repellent coating film on one side of the substrate.

### (2) Water-Repellent Coating Film

The water-repellent coating film which the water-repellent substrate of the present invention has, has the surface properties which satisfy the requirements of the above-described water splash property, and has film structure properties which satisfy the requirements of the porosity, and comprises an undercoat layer which comprises aggregates of metal oxide fine particles (A) having an average particle size of from 20 to 85 μm and a metal oxide binder, and which has a concave-convex surface, formed on the substrate side, and a water-repellent layer formed on the undercoat layer. The water-repellent coating film may consist solely of the undercoat layer and the water-repellent layer, but may have various functional layers such as an adhesion layer between the undercoat layer and the water-repellent layer within a range not to impair the surface properties and the film structure properties. The undercoat layer in a product of a water-repellent substrate in this specification may be an undercoat layer having a concave-convex surface, obtained by applying a composition for formation of undercoat layer containing aggregates of metal oxide fine particles (A) having an average primary particle size of from 20 to 85 μm and a metal oxide binder precursor on the substrate surface, followed by drying, and as the case requires, followed by heating.

Here, the undercoat layer is not necessarily directly formed on the surface of the substrate so long as it is provided on the substrate, and various functional layers, for example, a layer to modify the surface of the substrate or a layer (adhesion layer) to improve the adhesion to the undercoat layer may be provided as the case requires between the substrate and the undercoat layer. However, the water-repellent coating film which the water-repellent substrate of the present invention has does not include such layers formed between the substrate and the undercoat layer. In this specification, the water-repellent coating film means a laminated coating film including the respective layers from the undercoat layer to the surface water-repellent layer, and among the layers constituting the water-repellent coating film, the undercoat layer is formed on a side closest to the substrate.

The thickness of the water-repellent coating film is preferably from 50 to 600 nm, as the total thickness of the undercoat layer and the water-repellent layer, or in a case where various functional layers such as an adhesion layer are provided between the undercoat layer and the water-repellent layer, the total thickness of the undercoat layer and the water-repellent layer and such functional layers. The thickness of the water-repellent coating film is more preferably from 80 to 400 nm, further preferably from 100 to 300 nm. If the thickness of the water-repellent coating film is less than 50 nm or exceeds 600 nm, the concave-convex structure sufficient to attain the ultra-water-repellency may hardly be prepared. The thickness of the water-repellent coating film is the average thickness measured by the above method.

With respect to the arithmetic mean roughness of the surface of the water-repellent coating film which the water-repellent substrate of the present invention has, the arithmetic mean roughness (Ra) of the surface is preferably at least 15 nm and at most 40 nm as measured by a scanning probe microscope (SPM) in accordance with JIS R1683 (2007). The arithmetic mean roughness of the surface of the water-repellent coating film is more preferably at least 18 nm and at most 35 nm, further preferably at least 20 nm and at most 30 nm. If the arithmetic mean roughness of the water-repellent coating film is less than 15 nm, no sufficient water-repellency may be obtained on the surface of the water-repellent coating film. Further, if the arithmetic mean roughness of the surface of the water-repellent coating film exceeds 40 nm, the transparency of the water-repellent coating film may not be sufficient.

Further, the maximum peak-valley difference (P-V) of the concave-convex on the surface of the water-repellent coating film is preferably from 150 to 500 nm, more preferably from 250 to 450 nm. By such a surface structure, the water-repellent coating film which the water-repellent substrate of the present invention has, has water-repellent performance with the above water splash property of at least 100 mm. In this specification, the maximum peak-valley difference (P-V) of the concave-convex on the surface of the water-repellent coating film is a value measured by a scanning probe microscope (SPM).

Now, the respective layers constituting the water-repellent coating film will be described below.

### (2-1) Undercoat Layer

Among the layers constituting the water-repellent coating film, the undercoat layer is a layer formed on a side closest to the substrate, and is a layer containing aggregates of metal oxide fine particles (A) having an average primary particle size of from 20 to 85 nm and a metal oxide binder.

The undercoat layer is a layer having a concave-convex surface by containing aggregates of the metal oxide fine particles (A), and the water-repellent layer on the undercoat layer and functional layers provided between the undercoat layer and the water-repellent layer as the case requires are present so as to be substantially along the concave-convex structure on the surface of the undercoat layer. That is, the concave-convex structure on the surface of the undercoat layer is substantially the same as the concave-convex structure on the surface of the water-repellent coating film.

Further, the thickness of the undercoat layer is preferably from 45 to 590 nm, more preferably from 75 to 390 nm, particularly preferably from 95 to 290 nm, as the average thickness measured by the above method. When the thickness of the undercoat layer is at least 45 nm, when water droplets are dropped on the obtainable water-repellent coating film, a layer of air is partially formed between the undercoat layer surface and the water droplet, whereby sufficient ultra-water-repellency can be obtained. When the thickness of the undercoat layer is at most 590 nm, sufficient transparency can be secured. The thickness of the undercoat layer is the average thickness measured and calculated in the same manner as the measurement of the average thickness of the water-repellent coating film.

With respect to the content ratio of the aggregates of the metal oxide fine particles (A) to the metal oxide binder in the undercoat layer, when the mass of the aggregates of the metal oxide fine particles (A) is (a) and the mass of the metal oxide binder is (b), their mass ratio (a):(b) is preferably from 75:25 to 50:50, more preferably from 72:28 to 60:40, as calculated as metal oxides. When the ratio of the aggregates of the metal oxide fine particles (a) to the metal oxide binder is within such a range, the concave-convex of the obtainable undercoat layer is sufficient, and the ultra-water-repellency on the surface of the water-repellent coating film reflecting it can be obtained. Further, when the ratio of the aggregates of the metal oxide fine particles (a) to the metal oxide binder is within such a range, the porosity of the water-repellent coating film including the undercoat layer and the water-repellent layer is likely to be controlled to be within the above range of the present invention, and the strength of the undercoat layer can also be sufficiently secured.

### (Aggregates of Metal Oxide Fine Particles (A))

The aggregates of the metal oxide fine particles (A) which the undercoat layer of the water-repellent coating film contains are aggregates of metal oxide fine particles having an average primary particle size of from 20 to 85 nm. When the average primary particle size of the metal oxide fine particles (A) is within a range of from 20 to 85 nm, the transparency of the undercoat layer and the strength of the particles are maintained, such being advantageous. Further, the average primary particle size of the metal oxide fine particles (A) is preferably from 20 to 75 nm, more preferably from 20 to 60 nm.

In this specification, the value of the average primary particle size of the metal oxide fine particles (A) is a value obtained by observing the metal oxide fine particles (A) by a transmission type electron microscope (manufactured by Hitachi, Ltd., H-9000), whereby 100 particles are randomly selected, the particle sizes of the respective metal oxide fine particles (A) are measured, and the particle sizes of the 100 metal oxide fine particles (A) is averaged. Hereinafter, the average primary particle sizes of fine particles other than the metal oxide fine particles (A) are also values measured and calculated by the same method.

As the metal oxide fine particles (A) constituting the aggregates which the undercoat layer of the water-repellent coating film contains, either of fine particles having substantially no internal voids (solid fine particles) and fine particles having internal voids (hollow fine particles) may be used alone, or both of them may be used in combination. Selection between the solid fine particles and the hollow fine particles may suitably be made depending upon the particular application. For example, in a case where the water-repellent substrate of the present invention is to be used for a window glass for a transport machine such as an automobile, a window glass for building or a cover for a solar cell, transparency is required for the water-repellent substrate. Accordingly, it is preferred to use hollow fine particles. Further, even for such an application, as the case requires, it is possible to use solid fine particles and hollow fine particles in combination.

The metal oxide fine particles (A) may be specifically fine particles containing at least one metal oxide selected from the group consisting of silicon oxide, aluminum oxide, titanium oxide, tin oxide, zirconium oxide, cerium oxide, copper oxide, chromium oxide, cobalt oxide, iron oxide, manganese oxide, nickel oxide and zinc oxide. Among them, preferred are fine particles containing at least one metal oxide selected from the group consisting of silicon oxide, aluminum oxide, titanium oxide, tin oxide, zirconium oxide and cerium oxide, more preferred are fine particles containing at least one metal oxide selected from the group consisting of silicon oxide, aluminum oxide and zirconium oxide, and particularly preferred are fine particles containing silicon oxide. More specifically, preferred are fine particles composed substantially solely of silicon oxide (SiO₂), fine particles composed solely of aluminum oxide (Al₂O₃) or fine particles composed solely of zirconium oxide (ZrO₂), and particularly preferred are fine particles composed substantially solely of silicon oxide.

Here, “the fine particles containing a metal oxide” will be described with reference to fine particles containing silicon oxide (SiO₂) as an example. The fine particles containing silicon oxide are classified into fine particles of the following (i) to (iv) by the combination of the structure of the fine particles and the composition.

(i) Fine particles having substantially no internal voids and composed substantially solely of silicon oxide, i.e. solid fine particles composed substantially solely of silicon oxide.

(ii) Fine particles having substantially no internal voids, containing silicon oxide as the main component and further containing a metal oxide other than silicon oxide, i.e. solid fine particles containing silicon oxide as the main component and further containing a metal oxide other than silicon oxide.

(iii) Fine particles having internal voids, wherein the shell portion is composed substantially solely of silicon oxide, i.e. hollow fine particles each having a shell composed substantially of silicon oxide.

(iv) Fine particles having internal voids, wherein the shell portion contains silicon oxide as the main component and further contains a metal oxide other than silicon oxide, i.e. hollow fine particles wherein the shell portion contains silicon oxide as the main component and further contains a metal oxide other than silicon oxide.

Here, “having substantially no internal voids” means that no voids are observed when observed by using a transmission type electron microscope at an accelerating voltage of 100 kV with 200,000 magnifications. Further, fine particles composed substantially solely of silicon oxide mean that at least 99 mass % of the entire components constituting the fine particles are silicon oxide. Here, in this specification, “composed of silicon oxide” means that “composed substantially solely of silicon oxide”. Further, this definition applies to other metal oxides.

In the case of the above (ii) and (iv), the metal oxide other than silicon oxide may, for example, be aluminum oxide, titanium oxide, tin oxide, zirconium oxide, cerium oxide, copper oxide, chromium oxide, cobalt oxide, iron oxide, manganese oxide, nickel oxide or zinc oxide. Silicon oxide and the metal oxide other than silicon oxide may be in a state where they are simply mixed, or they may be present in the form of a composite oxide. Further, in the case of the above (ii), they may be core-shell type fine particles wherein the core is made of a metal oxide other than silicon oxide (such as zinc oxide) and the shell is made of silicon oxide. In such a case, they may be core-shell type fine particles wherein the composition of both of the metal oxide other than silicon oxide (such as zinc oxide) and silicon oxide is changed with a gradient from the center toward the outside.

In the case of the above (ii), the ratio of silicon oxide and other metal oxide contained in the fine particles is preferably such that the amount of the metal oxide other than silicon oxide is from 1.0 to 8.0 parts by mass per 100 parts by mass of silicon oxide, more preferably from 1.5 to 5.0 parts by mass. When the amount of the metal oxide other than silicon oxide is at least 1.0 part by mass, the strength of the fine particles tends to be sufficiently high, and when the amount of the metal oxide other than silicon oxide is at most 8.0 parts by mass, the refractive index of the fine particles can be controlled to be low.

When the amount of the metal oxide other than silicon oxide is at least 1 part by mass, the strength of the hollow fine particles tends to be sufficiently high, and when the amount of the metal oxide other than silicon oxide is at most 8.0 parts by mass, the refractive index of the hollow fine particles can be controlled to be low.

Here, the amount of the metal oxide other than silicon oxide is, in the case of aluminum, an amount calculated as aluminum oxide, in the case of copper, an amount calculated as copper oxide, in the case of cerium, an amount calculated as cerium oxide, in the case of tin, an amount calculated as tin oxide, in the case of titanium, an amount calculated as titanium oxide, in the case of chromium, an amount calculated as chromium oxide, in the case of cobalt, an amount calculated as cobalt oxide, in the case of iron, an amount calculated as iron oxide, in the case of manganese, an amount calculated as manganese oxide, in the case of nickel, an amount calculated as nickel oxide, and in the case of zinc, an amount as calculated as zinc oxide.

The above (i) to (iv) classified by the combination of the structure and the composition of the fine particles were described above with reference to silicon oxide as an example, and the same applies to the metal oxide fine particles (A) other than silicon oxide. The metal oxide fine particles (A) to be used in the present invention may be any of the above (i) to (iv) and may suitably be selected depending upon the particular application.

In the present invention, among them, solid silicon oxide fine particles having the above properties (i), solid aluminum oxide fine particles or solid zirconium oxide fine particles having the properties (i) wherein aluminum oxide or zirconium oxide is employed instead of silicon oxide, hollow silicon oxide fine particles having properties (iii), or hollow aluminum oxide fine particles or hollow zirconium oxide fine particles having properties (iii) wherein aluminum oxide or zirconium oxide is employed instead of silicon oxide, are preferably used.

The shape of the metal oxide fine particles (A) may be any of a spherical shape, a fusiform shape, a rod shape, an amorphous shape, a cylindrical shape, a needle shape, a flat shape, a scale shape, a leaf shape, a tubular shape, a sheet shape, a chain shape and a plate shape, and it is preferably a spherical shape or a rod shape. Here, “spherical shape” means that the aspect ratio is from 1 to 2.

Further, in a case where hollow fine particles are to be used as the metal oxide fine particles (A), the average shell thickness is preferably from 1 to 10 nm, particularly preferably from 2 to 5 nm. When the average shell thickness is at least 1 nm, it is possible to obtain an undercoat layer having a sufficient strength. When the average shell thickness is at most 10 nm, it is possible to control the refractive index of the particles to be low and to form an undercoat layer having high transparency.

Here, in a case where the metal oxide fine particles (A) are hollow fine particles, the average shell thickness is a value obtained by observing the metal oxide fine particles (A) by a transmission type electron microscope, whereby 100 fine particles are randomly selected, the average shell thicknesses of the respective metal oxide fine particles (A) are measured, and the obtained average shell thicknesses of the 100 metal oxide fine particles (A) are averaged.

The method for producing the metal oxide fine particles (A) is not particularly limited so long as the above-described properties of the metal oxide fine particles (A), for example, the respective properties of the metal oxide fine particles (A) classified into the above (i) to (iv) are obtained. Specifically, it will be described together with the method for producing the aggregates of the metal oxide fine particles (A) in the after-mentioned process for producing the water-repellent substrate of the present invention, as the case requires. The method for producing the core-shell type metal oxide fine particles (A) will also be described in the after-mentioned process for producing the water-repellent substrate of the present invention.

For the aggregates of the metal oxide fine particles (A) having an average primary particle size of from 20 to 85 nm, which are one component constituting the undercoat layer, it is preferred to use the hollow metal oxide fine particles (A) as the metal oxide fine particles (A) as described above. Further, the hollow metal oxide fine particles (A) are particularly preferably hollow metal oxide fine particles (A) obtainable by irradiation with microwaves in the after-mentioned preparation of core-shell type fine particles. Further, the core fine particles are preferably made of zinc oxide. In a case where zinc oxide is used as the core fine particles and heating is carried out by microwaves, the core fine particles are selectively heated, whereby a dense shell can be formed, and the strength of the obtainable undercoat layer will be increased, such being desirable. Further, the metal oxide constituting the shell of the hollow metal oxide fine particles (A) is preferably silica (silicon oxide). Accordingly, in the present invention, hollow silica fine particles are preferably used as the metal oxide fine particles (A) for the aggregates of the metal oxide fine particles (A) which are one component constituting the undercoat layer.

In order to attain ultra-water-repellency of the surface of the water-repellent coating film, a relatively large concave-convex structure is required, and accordingly, the aggregates of the metal oxide fine particles (A) are used as mentioned above. However, the scattering intensity of light becomes high as the particle size increases, whereby the transparency is likely to be lost. On the other hand, the scattering intensity of light depends also on the refractive index of particles, and becomes low as the difference in the refractive index from air (refractive index: 1) is small. Accordingly, the refractive index of the aggregates of the metal oxide fine particles (A) to be used in the present invention is preferably at most 1.4, more preferably from 1.05 to 1.35, particularly preferably from 1.1 to 1.3. When the refractive index of the aggregates of the metal oxide fine particles (A) is at least 1.05, the strength of the undercoat layer can sufficiently be secured. Further, when the refractive index of the aggregates of the metal oxide fine particles (A) is at most 1.4, it is possible to obtain an undercoat layer having high transparency. Thus, by adjusting the refractive index of the aggregates of the metal oxide fine particles (A), it is possible to obtain a water-repellent substrate excellent in the water-repellency and transparency. Further, a water-repellent substrate obtainable by using the aggregates of the metal oxide fine particles (A) having a refractive index of from about 1.1 to 1.3, exhibits good transparency, can secure a sufficient visual field and further exhibits an excellent antireflection performance. Accordingly, it is particularly useful for a vehicle window of e.g. an automobile or for a cover for a solar cell.

In the present invention, the refractive index of the aggregates of the metal oxide fine particles (A) does not mean refractive indices of individual materials constituting the aggregates, i.e. the metal oxide fine particles (A), but means the refractive index as the entire aggregates. The refractive index as the entire aggregates is calculated from the minimum reflectance measured by a spectrophotometer. In a case where the undercoat layer contains a binder, as in the case of the undercoat layer to be used in the present invention, the refractive index of a film is calculated by the minimum reflectance measured by a spectrophotometer in a state as the film (layer) including the binder, and the refractive index as the entire aggregates is calculated from the weight ratio of the aggregates and the binder.

### (Metal Oxide Binder)

The undercoat layer which is one of layers constituting the water-repellent coating film of the present invention contains, in addition to the aggregates of the metal oxide fine particles (A), a metal oxide binder. The metal oxide constituting the metal oxide binder is preferably at least one metal oxide selected from the group consisting of silicon oxide, aluminum oxide, titanium oxide, tin oxide and cerium oxide, particularly preferably silicon oxide.

The metal oxide binder is a component formed by a binder material containing a metal compound to be a metal oxide by a hydrolytic condensation reaction or pyrolysis, i.e. a metal compound to be a precursor for the metal oxide binder, and formation of the metal oxide binder from such a binder material will be described in detail in the process for producing a water-repellent substrate of the present invention.

### (Optional Component)

The underlayer preferably contains, as an optional component, aggregates of metal oxide fine particles (C) having a small average primary particle size, specifically, an average primary particle size at a level of from 3 to 18 nm, preferably at a level of from 3 to 10 nm, having lower aggregation properties than the aggregates of the metal oxide fine particles (A), in other words, having a high dispersability. In a case where the undercoat layer contains aggregates of metal oxide fine particles (C), the content is at most 200 mass % based on the content of the aggregates of the metal oxide fine particles (A). If the undercoat layer contains the aggregates of metal oxide fine particles (C) in an amount exceeding 200 mass % based on the aggregates of the metal oxide fine particles (A), no sufficient concave-convex will be formed on the undercoat layer, and the above-mentioned ultra-water-repellency which the water-repellent substrate of the present invention has will not be attained.

In a case where the undercoat layer contains the aggregates of metal oxide fine particles (C), the content is at most 200 mass % based on the content of the aggregates of the metal oxide fine particles (A) as mentioned above, and is preferably within a range of from 5 to 100 mass %, more preferably from 10 to 90 mass %.

In a case where the undercoat layer contains the aggregates of metal oxide fine particles (C), the ratio of the total content of the aggregates of the metal oxide fine particles (A) and the aggregates of the metal oxide fine particles (C) to the content of the metal oxide binder precursor is preferably from 90:10 to 50:50, more preferably from 80:20 to 60:40, as the mass ratio as calculated as metal oxides. In such a case also, the content ratio of the aggregates of the metal oxide fine particles (A) to the metal oxide binder precursor is preferably from 75:25 to 50:50, more preferably from 72:28 to 60:40, as the mass ratio as calculated as metal oxides.

By containing the aggregates of the metal oxide fine particles (C), gaps among the aggregates of the metal oxide fine particles (A) can moderately be filled, thus increasing the mechanical strength and the heat resistance of the undercoat layer, and reducing the shrinkage on curing at the time of layer formation. Such metal oxide fine particles (C) are preferably metal oxide fine particles having transparency. The metal oxide fine particles (C) may, for example, be silica fine particles, alumina fine particles, titania fine particles, zirconia fine particles, ITO fine particles, ceria fine particles or tin oxide fine particles, and among them, silica fine particles, zirconia fine particles or the like are preferred, and silica fine particles are more preferred. They may be used alone or in combination of two or more.

In a case where ITO fine particles are used as the metal oxide fine particles (C), the mechanical strength and the heat resistance of the undercoat layer can be increased as mentioned above, and in addition, as ITO has infrared absorption properties, infrared absorption properties can be imparted to the undercoat layer.

### (Undercoat Layer Reinforcing Treatment)

In the present invention, it is possible to use, as the undercoat layer, such an undercoat layer that gaps in the interior are impregnated with a composition containing a polysilazane and a part or all of the gaps of the undercoat layer are filled with silicon oxide formed by hydrolytic condensation or pyrolysis of the polysilazane. The undercoat layer obtainable in such a manner is preferably used in the present invention as an undercoat layer having a reduced porosity of an undercoat layer obtainable by curing the above composition for formation of undercoat layer and increased hardness, and thus improved abrasion resistance as a whole. A specific method of the undercoat layer reinforcing treatment will be described in the after-mentioned process for producing a water-repellent substrate of the present invention.

### (2-2) Water-Repellent Layer

The water-repellent coating film which the water-repellent substrate of the present invention has, has a water-repellent layer on the undercoat layer formed on the substrate. The water-repellent layer is a layer formed on the outermost surface of the water-repellent coating film, in other words, at a position furthest from the substrate, and is not necessarily directly provided on the surface of the undercoat layer so long as it is located above the undercoat layer. Accordingly, between the undercoat layer and the water-repellent layer, various functional layers such as an adhesion layer may be provided as the case requires.

In the water-repellent coating film according to the present invention, the surface of the water-repellent layer also has the concave-convex structure reflecting the concave-convex structure on the surface of the undercoat layer, and this concave-convex structure contributes to the surface water-repellency.

The water-repellent layer contains a water-repellent material. The water-repellent material constituting the water-repellent layer is not particularly limited, and a silicone type water-repellent material may, for example, be used. In the present invention, a water-repellent material formed by a hydrolytic condensation reaction from a silicone type water-repellent agent or a water-repellent agent containing a hydrophobic organic silicon compound is preferably used. The water-repellent agent will be described in the process for producing a water-repellent substrate of the present invention.

The thickness of the water-repellent layer is preferably from 1 to 10 nm, more preferably from 2 to 5 nm. The water-repellent layer formed on the undercoat layer is a very thin layer, whereby the three dimensional shape of the water-repellent layer surface reflects the three dimensional shape of the undercoat layer surface and thus has a similar shape.

The water-repellent agent contained in the water-repellent layer is, in a case where the water-repellent layer is directly formed on the surface of the undercoat layer, bonded at least to the convex upper surface of the undercoat layer and may be bonded to portions (portions other than the convex upper surface) such as concaves or spaces in the undercoat layer formed due to the shape of the aggregates of the metal oxide fine particles (A). In a case where the water-repellent agent is deposited not only on the concave upper surface of the undercoat layer but also in the concaves or spaces in the undercoat layer, even if the water-repellency on the convex upper surface of the water-repellent article is lowered by the abrasion during the use, the water-repellent performance can be maintained by the water-repellent agent present at the portions such as concaves or spaces in the undercoat layer, such being desirable.

The water-repellent coating film which the water-repellent substrate of the present invention has may have various functional layers between the undercoat layer and the water-repellent layer within a range not to impair the effects of the present invention. Such functional layers may, for example, be an adhesion layer to improve the adhesion between the undercoat layer and the water-repellent layer. The adhesion layer is preferably a layer of silicon oxide formed from a silicon compound other than a polysilazane (for example, a silicon compound having a hydrolysable group such as an alkoxy group, an isocyanate group or a halogen atom bonded to a silicon atom). The thickness of the adhesion layer is preferably from 1 to 10 nm, more preferably from 2 to 5 nm. Further, the surface of the adhesion layer obtainable as mentioned above reflects the concave-convex structure of the undercoat layer and thus has a similar concave-convex structure.

Here, the water-repellent layer and the adhesion layer and other functional layers which are provided as the case requires may not necessarily cover the entire surface of the layer located thereunder. That is, so long as the function of each layer is sufficiently obtained, there may be a partial portion where such a layer is not formed.

### <Process for Producing Water-Repellent Substrate>

The water-repellent substrate of the present invention has a water-repellent coating film comprising the above-described undercoat layer and water-repellent layer and having the above surface properties on at least one side of a substrate. A process for producing such a water-repellent substrate of the present invention comprises at least the following steps (I) and (II) in order.

(I) A step of applying, on at least one side of a substrate, a composition for formation of undercoat layer containing aggregates of metal oxide fine particles, a metal oxide binder precursor and a dispersing medium, and having the following properties (Ia) or (Ib), followed by drying to form an undercoat layer which has a concave-convex surface derived from the aggregates (hereinafter referred to as “undercoat layer forming step”).

(Ia) A composition for formation of undercoat layer wherein the aggregates of the metal oxide fine particles mainly consists of aggregates of metal oxide fine particles (A) having an average primary particle size of from 20 to 85 nm and a volume average aggregate particle size of from 200 to 600 nm, and the aggregates of the metal oxide fine particles (A) and the metal oxide binder precursor are contained in a mass ratio of from 75:25 to 50:50 as calculated as metal oxides (hereinafter sometimes referred to as “composition (Ia) for formation of undercoat layer”).

(Ib) A composition for formation of undercoat layer, wherein the aggregates of the metal oxide fine particles mainly consists of aggregates of the metal oxide fine particles (A) and aggregates of metal oxide fine particles (C) having an average primary particle size of from 3 to 18 nm and a volume average aggregate particle size of from 3 to 30 nm in an amount of from 5 to 200 mass % of the content of the aggregates of the metal oxide fine particles (A), the aggregates of the metal oxide fine particles and the metal oxide binder precursor are contained in a mass ratio of from 75:25 to 50:50 as calculated as metal oxides, and the aggregates of the metal oxide fine particles and the metal oxide binder precursor are contained in a mass ratio of from 90:10 to 50:50 as calculated as metal oxides (hereinafter sometimes referred to as composition (Ib) for formation of undercoat layer).

(II) A step of applying a composition for formation of water-repellent layer containing a water-repellent agent on the surface of the undercoat layer obtained in the above (I), followed by drying to form a water-repellent layer on the surface of the undercoat layer thereby to form a water-repellent coating film having an average thickness of from 50 to 600 nm (hereinafter referred to as “water-repellent layer forming step”).

Further, in the above undercoat layer forming step (I), after the composition for formation of undercoat layer is applied and dried, a step of impregnating the obtained undercoat layer with a composition containing a polysilazane to fill a part or all of gaps in the undercoat layer with silicon oxide formed by hydrolytic condensation or pyrolysis of the polysilazane, may further be conducted, and the process for producing a water-repellent substrate of the present invention preferably comprises this treatment.

Further, in a case where the water-repellent coating film which the water-repellent substrate of the present invention has, has an adhesion layer between the undercoat layer and the water-repellent layer, between the above steps (I) and (II), a step (I)′ of applying a composition for formation of adhesion layer containing an adhesion improving component on the surface of the undercoat layer, followed by drying to form an adhesion layer along the concave-convex structure on the surface of the undercoat layer (hereinafter referred to as “adhesion layer forming step”) is conducted, and the step (II) is carried out in the same manner except that the composition for formation of water-repellent layer is applied “on the surface of the adhesion layer” instead of “on the surface of the undercoat layer”, to produce the water-repellent substrate of the present invention.

Here, the undercoat layer is not necessarily directly provided on the surface of a substrate so long as the undercoat layer is formed on the substrate, and between the substrate layer and the undercoat layer, various functional layers such as a layer to modify the surface of the substrate and a layer to improve the adhesion to the undercoat layer may be provided as the case requires. The water-repellent coating film which the water-repellent substrate of the present invention has does not include a layer formed between the substrate and the undercoat layer, but means a laminated coating film including the respective layers from the undercoat layer to the water-repellent layer on the surface, and among the layers constituting the water-repellent coating film, the undercoat layer is formed on a side closest to the substrate.

Now, the above undercoat layer forming step (I), water-repellent layer forming step (II) and adhesion layer forming step (I)′ will be described below.

(I) Undercoat Layer Forming Step

The undercoat layer forming step is a step of applying on at least one side of a substrate a composition for formation of undercoat layer having the after-described specific composition, followed by drying to form an undercoat layer having a concave-convex surface.

In the production process of the present invention, the water-repellent layer is formed on the undercoat layer and as the case requires, a functional layer is formed between the undercoat layer and the water-repellent layer, and as they are formed substantially along the concave-convex structure on the surface of the undercoat layer, the concave-convex structure on the surface of the water-repellent coating film directly reflects the concave-convex structure on the surface of the undercoat layer formed in this undercoat layer forming step. Accordingly, in the production process of the present invention, by controlling the concave-convex structure on the surface of the undercoat layer so that the arithmetic mean roughness (Ra) of the surface of the water-repellent coating film is from 15 nm to 40 nm as mentioned above and that the maximum peak-valley difference (P-V) of the concave-convex on the surface is from 150 to 500 nm, it is possible to obtain ultra-water-repellency represented by the value of the water splash property while the obtainable water-repellent substrate maintains transparency on the surface of the water-repellent coating film.

The substrate used in the undercoat layer forming step may be the same substrate as described for (1) substrate in the above water-repellent substrate of the present invention.

(I-1) Composition for Formation of Undercoat Layer

In the undercoat layer forming step, the composition for formation of undercoat layer to be applied on the substrate is a composition containing aggregates of metal oxide fine particles, a metal oxide binder precursor and a dispersing medium, and having properties (Ia) or (Ib) in the components contained and the composition. Hereinafter the composition for formation of undercoat layer includes both the composition (Ia) for formation of undercoat layer and the composition (Ib) for formation of undercoat layer.

### (Aggregates of Metal Oxide Fine Particles (A))

The aggregates of the metal oxide fine particles (A) which both of the composition (Ia) for formation of undercoat layer and the composition (Ib) for formation of undercoat layer have, are aggregates having a volume average aggregate particle size of from 200 to 600 nm, obtained by aggregation of the metal oxide fine particles (A) having an average primary particle size of from 20 to 85 nm.

The volume average aggregate particle size of the aggregates of the metal oxide fine particles (A) is from 200 to 600 nm, and is preferably from 300 to 500 nm. When the volume average aggregate particle size of the aggregates of the metal oxide fine particles (A) is at least 200 nm, when an undercoat layer containing such aggregates is formed on the substrate, gaps having an appropriate size are formed among aggregate particles on the surface of the undercoat layer, that is, the concave-convex on the surface is formed. By forming the concave-convex on the undercoat layer, when water drops are deposited, ultra-water-repellency can be attained including air. Further, when the volume average aggregate particle size of the aggregates of the metal oxide fine particles (A) is at most 600 nm, internal voids in the water-repellent coating film can be reduced, whereby sufficient abrasion resistance will be obtained.

In this specification, the volume average aggregate particle size of the aggregates of the metal oxide fine particles (A) is a value D50 determined by the volume distribution by measurement by using a dynamic light scattering particle size analyzer (manufactured by NIKKISO CO., LTD., MICROTRAC UPA). Hereinafter, the volume average aggregate particle sizes of the aggregates of fine particles other than the aggregates of the metal oxide fine particles (A) are also values measured and calculated in the same method.

The size, the shape, the constituting compound, etc. of the metal oxide fine particles (A) are the same as described in the water-repellent substrate of the present invention including preferred embodiments.

The method for producing the metal oxide fine particles (A) to be used in the present invention is not particularly limited, and specifically, as the case requires, it will be described below together with the method for producing the aggregates of the metal oxide fine particles (A). Particularly the method for producing core-shell type metal oxide fine particles (A) will be described below.

The method for producing the aggregates of the metal oxide fine particles (A) is not particularly limited, and specifically, the following methods capable of producing aggregates having the above preferred volume average aggregate particle size may be employed.

Method (1): A method of aggregating metal oxide fine particles (A) having a desired average primary particle size to obtain aggregates having a desired volume average aggregate particle size.

Method (2): A method of disintegrating aggregates obtained from metal oxide fine particles (A) having a desired average primary particle size to obtain aggregates having a desired volume average aggregate particle size.

The methods (1) and (2) may be adopted irrespective of solid fine particles (including core-shell type fine particles) or hollow fine particles.

Specifically, the method (1) may be carried out by adding a substance (additive) capable of lowering the surface charge or capable of bonding particles to one another, to a dispersion liquid wherein the metal oxide fine particles (A) having a desired average primary particle size are dispersed, followed by heating and aging, as the case requires.

In this method, the volume average aggregate particle size of the aggregates can be adjusted by adjusting the amount of the additive, the heating temperature, the heating time and the like. Usually, the heating temperature is from 30 to 500° C., and the heating time is from one minute to 12 hours. As the additives, a surface charge controlling agent such as an ion exchange resin, potassium nitrate or sodium polyaluminate, or a particle-bonding agent such as sodium silicate or tetraethoxysilane may be used. The amount of the additive is preferably at most 10 mass % based on the solid content of the metal oxide fine particles (A).

Further, as the above method (2) to produce the aggregates of the metal oxide fine particles (A), specifically, a method of preparing a dispersion liquid having, dispersed in a dispersing medium, metal oxide fine particles (A) having a desired average primary particle size and/or aggregates of such metal oxide fine particles (A), then removing the dispersing medium to obtain a solid content, and disintegrating the solid content by means of e.g. a ball mill, a bead mill, a sand mill, a homomixer or a paint shaker, may be mentioned.

In the above method, removal of the dispersing medium can be carried out, specifically, by the following methods.

(a) A method of heating the dispersion liquid of metal oxide fine particles to volatilize the dispersing medium.

(b) A method of subjecting the dispersion liquid of metal oxide fine particles to solid-liquid separation to obtain the solid content.

(c) A method of employing a spray dryer to spray the dispersion liquid of metal oxide fine particles into a heated gas to volatilize the dispersing medium, etc. (spray drying method).

(d) A method of cooling the dispersion liquid of metal oxide fine particles under reduced pressure to sublime the dispersing medium, etc. (freeze drying method).

The aggregates of the metal oxide fine particles (A) to be used in the present invention can be produced in such a manner. A method for producing aggregates of hollow metal oxide fine particles (A) as a preferred embodiment of the aggregates of the metal oxide fine particles (A) will be specifically described below, as a method for producing aggregates of core-shell type metal oxide fine particles (A).

In a case where core-shell type fine particles are used to obtain aggregates composed of hollow fine particles, such an operation can be carried out with reference to e.g. JP-A-2006-335881 or JP-A-2006-335605 by the present applicant.

The method for producing core-shell type fine particles may be a gas phase method or a liquid phase method. In a method by a gas phase method, core-shell type fine particles can be produced by applying plasma to the material for core fine particles and the silicon oxide material such as metal Si. In a case where the core-shell type metal oxide fine particles (A) are producing by a gas phase method, the component forming the core may be removed as the case requires to obtain hollow fine particles, followed by dispersion in a dispersing medium by means of a dispersing machine such as a bead mill, whereby aggregates having a desired volume average aggregate particle size can be obtained. As a method of removing the core component, the same method in the after-mentioned liquid phase method may be employed.

As a method for producing the core-shell type fine particles by a liquid phase method, a method may be mentioned wherein first, a precursor for a metal oxide such as silicon oxide and, as the case requires, water, an organic solvent, an acid, an alkali, a curing catalyst, etc. are added to a dispersion liquid having clusters of core fine particles dispersed in a dispersing medium, to prepare a raw material liquid (hereinafter sometimes referred to as “core-shell type fine particle raw material liquid” to produce core-shell type fine particles, and then at the same time as the raw material liquid is heated, the precursor for a metal oxide such as silicon oxide is hydrolyzed to precipitate a metal oxide such as silicon oxide on the surface of the clusters of core fine particles to form a shell thereby to obtain aggregates of core-shell type fine particles.

As the core fine particles to be used for the liquid phase method, when finally used as solid core-shell type fine particles containing core fine particles for the present invention, fine particles composed of the above metal oxide are used as the component constituting the metal oxide fine particles (A). When the core-shell type fine particles are finally used as hollow fine particles having the core portion removed for the present invention, the core fine particles are not particularly limited so long as they are fine particles made of a material which is commonly used for the preparation of the core-shell type fine particles.

For example, in a case where aggregates of hollow fine particles are to be obtained, ones soluble, decomposable or sublimable by heat, acid or light are preferably used as the material constituting the core fine particles. Such a core fine particle constituting material may, for example, be specifically at least one member selected from the group consisting of heat decomposable organic polymer fine particles of e.g. a surfactant micelle, a water-soluble organic polymer, a styrene resin or an acrylic resin; acid-soluble inorganic fine particles of e.g. sodium aluminate, calcium carbonate, basic zinc carbonate or zinc oxide; metal chalcogenide semiconductor particles of e.g. zinc sulfide or cadomium sulfide; and photo-soluble inorganic fine particles of e.g. zinc oxide.

Further, in a method where heating of the core-shell type fine particle raw material liquid is carried out by the after-mentioned irradiation with microwaves to form a shell, the core fine particles are preferably fine particles made of a material having a dielectric constant of at least 10, preferably from 10 to 200. When the dielectric constant of the material of the core fine particles is at least 10, microwaves can easily be absorbed, and accordingly, the core fine particles can be heated selectively to a high temperature (at least 100° C.) by microwaves. The dielectric constant can be calculated from the values of the reflection coefficient and the phase measured by applying an electric field to a sample by a bridge circuit by means of a network analyzer.

The material for core fine particles having a dielectric constant of at least 10 may, for example, be zinc oxide, titanium oxide, indium tin oxide (ITO), aluminum oxide, zirconium oxide, zinc sulfide, gallium arsenide, iron oxide, cadomium oxide, copper oxide, bismuth oxide, tungsten oxide, cerium oxide, tin oxide, gold, silver, copper, platinum, palladium, ruthenium, iron platinum or carbon.

In a case where the obtainable core-shell type fine particles are to be finally used as solid core-shell type fine particles (metal oxide fine particles (A)) containing the core fine particles for the present invention, among such materials for the core fine particles, it is preferred to use zinc oxide, titanium oxide, ITO, aluminum oxide, zirconium oxide, zinc sulfide, cerium oxide or tin oxide, since it is thereby possible to obtain a film having high transparency.

The shape of the core fine particles to be used in the above liquid phase method is not particularly limited. For example, particles of a spherical shape, a fusiform shape, a rod shape, an amorphous shape, a cylindrical shape, a needle shape, a flat shape, a scale shape, a leaf shape, a tubular shape, a sheet shape, a chain shape or a plate shape may be used. Particles having different shapes may be used in combination. Further, if the core fine particles are monodispersed, aggregate particles tend to be hardly obtainable, and therefore, it is preferred to use clusters having from 2 to 10 core fine particles clustered.

Among the above core fine particles of various shapes, in the present invention, core fine particles of a spherical shape are preferably used. In such a case, the average primary particle size of the core fine particles is preferably from 5 to 75 nm, particularly preferably from 5 to 70 nm. When the average primary particle size of the core fine particle is at least 5 nm, the strength of the obtainable core-shell type fine particles will be maintained. When the average primary particle size of the core fine particles is at most 75 nm, the transparency of the undercoat layer will be maintained. Further, the volume average aggregate particle size of the aggregates of core fine particles is preferably from 50 to 600 nm, particularly preferably from 100 to 500 nm. When the volume average aggregate particle size is at least 50 nm, concave-convex will be formed on the film surface when applied on the substrate, whereby when water drops are dropped thereon, ultra-water-repellency becomes easily obtainable including air. When the volume average aggregate particle size is at most 600 nm, the porosity in the interior of the film can be controlled to be low, and the concave-convex structure will easily be maintained even when abraded by application of abrasion conditions.

Various methods may be employed to obtain a state where the core fine particles are dispersed in a dispersing medium preferably in a form of clusters (aggregates). For example, a method of preparing core fine particles in a dispersing medium; or a method of adding the after-mentioned dispersing medium and dispersant to a core fine particle powder, followed by deflocculation by means of a dispersing machine such as a ball mill, a bead mill, a sand mill, a homomixer or a paint shaker, may be mentioned.

The content of the core fine particles in the dispersion liquid having the above clusters (aggregates) of the core fine particles dispersed in a dispersing medium is preferably from 0.1 to 40 mass %, more preferably from 0.5 to 20 mass % as the amount of the core fine particles based on the entire amount of the dispersion liquid.

When the content of the core fine particles in the dispersion liquid is within the above range, the stability of the dispersion liquid is good, and the production efficiency for core-shell type fine particles will be good.

The dispersing medium for the core fine particles is not necessarily required to contain water, but when it is used at it is in the subsequent step for hydrolytic condensation of the metal oxide precursor, the dispersing medium is preferably water alone or a mixed medium of water and the organic solvent. Such an organic solvent is an organic solvent which is at least partially soluble in water or preferably capable of partially dissolving water, and it is more preferably an organic soluble miscible with water.

Such an organic solvent may, for example, be specifically an alcohol (such as methanol, ethanol or isopropanol), a ketone (such as acetone or methyl ethyl ketone), an ether (such as tetrahydrofuran or 1,4-dioxane), an ester (such as ethyl acetate or methyl acetate), a glycol ether (such as ethylene glycol monoalkyl ether), a nitrogen-containing compound (such as N,N-dimethylacetamide or N,N-dimethylformamide) or a sulfur-containing compound (such as dimethylsulfoxide).

In a case where the dispersing medium is a mixed medium of water with the above organic solvent, such a mixed medium preferably contains at least 5 mass % of water, based on the entire medium. If the content of water is less than 5 mass %, the hydrolytic condensation reaction may not sufficiently proceed. Further, it is necessary to let water be present in the system in an amount of at least the stoichiometric amount to the hydroxy groups or hydrolyzable groups bonded to silicon atoms in the silicon oxide precursor in the dispersion liquid.

Then, circumference of clusters (aggregates) of the core fine particles is covered with a metal oxide such as silicon oxide to obtain aggregates of the core-shell fine particles. Specifically, they are obtained by adding a precursor for a metal oxide (such as silicon oxide) to the above-obtained dispersion liquid of the core fine particle clusters, and reacting the precursor for a metal oxide in the presence of clusters of the core fine particles e.g. by heating to precipitate a metal oxide (such as silicon oxide) on the surface of the clusters of the core fine particles to form a shell.

The amount of the metal oxide precursor to be added to the dispersion liquid of the clusters of the core fine particles for formation of a shell is preferably an amount whereby the average shell thickness of the obtainable core-shell type fine particles will be from 1 to 10 nm, more preferably from 2 to 5 nm. The amount of the metal oxide precursor (calculated as metal oxides) is specifically preferably from 3 to 1,000 parts by mass per 100 parts by mass of the core fine particles.

Further, the solid content concentration (total concentration of the core fine particles (clusters) and the metal oxide precursor (as calculated as metal oxides) for formation of shell) in the core-shell type fine particle raw material liquid to be used for production of the core-shell type fine particles, is preferably within a range of at least 0.1 mass % and at most 30 mass %, particularly preferably within a range of at least 1 mass % and at most 20 mass %. If the solid content concentration exceeds 30 mass %, the stability of the fine particle dispersion liquid tends to be decreased. If it is less than 0.1 mass %, the productivity of the obtainable aggregates of the core-shell type fine particles, for example, aggregates of hollow silica fine particles tends to be very low.

In a case where the metal oxide is silicon oxide, the precursor for silicon oxide may be at least one compound selected from the group consisting of silicic acid, a silicate and a silicic acid alkoxide. Such a compound is a compound having at least one hydroxy group or hydrolyzable group (such as a halogen atom or an alkoxy group) bonded to a silicon atom. For such a precursor, different types of compounds may be used in combination. Further, such a precursor may be a partially hydrolyzed condensate.

The silicic acid may be silicic acid obtainable by a method of decomposing an alkali metal silicate with an acid, followed by dialysis; a method of deflocculating an alkali metal silicate; or a method of contacting an alkali metal silicate with an acid-form cation exchange resin.

The silicate may, for example, be an alkali metal silicate such as sodium silicate or potassium silicate; an ammonium silicate such as tetraethylammonium silicate; or a salt of silicic acid with an amine (such as ethanolamine).

The silicic acid alkoxide may be a compound having four alkoxy groups bonded to a silicon atom, such as tetraethoxysilane. Otherwise, it may be a silicic acid alkoxide having from 1 to 3 organic groups bonded to a silicon atom. As such an organic group, a monovalent organic group containing a functional group such as a vinyl group, an epoxy group or an amino group; or a fluorinated monovalent organic group such as a perfluoroalkyl group or a perfluoroalkyl group containing an etheric oxygen atom, may, for example, be mentioned.

The silicic acid alkoxide having a silicon atom having such organic groups bonded thereto may, for example, be vinyl trimethoxysilane, vinyl triethoxysilane, 2-(3,4-epoxycyclohexyl)ethyltrimethoxysilane, 3-glycidoxypropyltrimethoxysilane, 3-glycidoxypropylmethyldiethoxysilane, 3-glycidoxypropyltriethoxysilane or perfluoroethyltriethoxysilane.

To the above core-shell type fine particle raw material liquid, in addition to the above core fine particles (clusters), precursor for a metal oxide for formation of shell and dispersing medium, as the case requires, an alkali, an acid, a curing catalyst or the like may be added.

The alkali may, for example, be potassium hydroxide, sodium hydroxide, ammonia, ammonium carbonate, ammonium hydrogencarbonate, dimethylamine, triethylamine or aniline, and ammonia is preferred, since it is removable by heating. The amount of the alkali is preferably an amount whereby the pH of the core-shell type fine particle raw material liquid will be from 8.5 to 10.5, more preferably from 9.0 to 10.0, since the precursor for a metal oxide will thereby be three dimensionally polymerized to readily form a dense shell.

The acid may, for example, be hydrochloric acid or nitric acid. Here, zinc oxide particles are soluble in an acid, and when zinc oxide particles are used as core fine particles, the hydrolysis of the precursor for a metal oxide is preferably carried out by an alkali. The amount of the acid is preferably an amount whereby the pH of the core-shell type fine particle raw material liquid will be from 3.5 to 5.5.

The curing catalyst may, for example, be a metal chelate compound, an organic tin compound, a metal alcoholate or a metal fatty acid salt, and from the viewpoint of the strength of the shell, a metal chelate compound or an organic tin compound is preferred, and a metal chelate compound is particularly preferred. When a metal chelate compound is added, chain solid fine particles are likely to be formed as a by-product, whereby a structure wherein hollow fine particles are linked to one another by the chain solid fine particles, is likely to be formed.

The metal chelate may, for example, be an aluminum chelate compound (such as aluminum acetyl acetonate, aluminum bisethylacetoacetate monoacetyl acetonate, aluminum-di-n-butoxide-monoethylacetoacetate, aluminum-di-isopropoxide-monomethylacetoacetate or diisopropoxy aluminum ethyl acetate), a titanium chelate compound (such as titanium acetylacetonate or titanium tetraacetylacetonate), a copper chelate compound (such as copper acetylacetonate), a cerium chelate compound (such as cerium acetylacetonate), a chromium chelate compound (such as chromium acetylacetonate), a cobalt chelate compound (such as cobalt acetylacetonate), a tin chelate compound (such as tin acetylacetonate), an iron chelate compound (such as iron(III) acetylacetonate), a manganese chelate compound (such as manganese acetylacetonate), a nickel chelate compound (such as nickel acetylacetonate), a zinc chelate compound (such as zinc acetylacetonate) or a zirconium chelate compound (such as zirconium acetylacetonate). From the viewpoint of the strength of hollow fine particles, an aluminum chelate compound, particularly aluminum acetylacetonate, is preferred.

The amount of the curing catalyst (calculated as metal oxides) is preferably from 0.1 to 20.0 parts by mass, more preferably from 0.2 to 8.0 parts by mass, per 100 parts by mass of the amount of the precursor for a metal oxide (calculated as metal oxides).

Further, at the time of producing the core-shell type fine particle raw material liquid, in order to increase the ionic strength of the raw material liquid to facilitate formation of a shell from the precursor for a metal oxide such as silicon oxide, an electrolyte such as sodium chloride, potassium chloride, magnesium chloride, sodium nitrate, potassium nitrate, sodium sulfate, potassium sulfate, ammonia or sodium hydroxide may be added. Further, by using such an electrolyte, the pH of the reaction solution may be adjusted.

Heating of the core-shell type fine particle raw material liquid may be carried out not only by usual heating but also by irradiation with microwaves. The microwaves mean electromagnetic waves having a frequency of from 300 MHz to 300 GHz. Usually, microwaves having a frequency of 2.45 GHz are used, but the microwaves are not limited thereto, and a frequency may be selected so that the object to be heated can effectively be thereby heated. By the radio law, frequency bands so-called ISM bands are prescribed for applications to use radio waves for the purpose of other than communication, and it is possible to use microwaves of e.g. 433.92 (±0.87) MHz, 896 (±10) MHz, 915 (±13) MHz, 2375 (±50) MHz, 2450 (±50) MHz, 5800 (±75) MHz, 24125 (±125) MHz, etc.

The output power of microwaves is preferably an output power whereby the core-shell type fine particle raw material liquid is heated to from 30 to 500° C., more preferably an output power whereby the raw material liquid is heated to from 50 to 300° C. When the temperature of the core-shell type fine particle raw material liquid is at least 30° C., a dense shell can be formed in a short time. When the temperature of the core-shell type fine particle raw material liquid is at most 500° C., the amount of a metal oxide precipitating on other than the surface of core fine particles can be suppressed.

The time for irradiation with microwaves may suitably be adjusted to a time wherein a shell having a desired thickness can be formed depending upon the output power of microwaves (the temperature of the core-shell type fine particle raw material liquid), and it is, for example, from 10 seconds to 60 minutes.

As mentioned above, it is possible to heat the core fine particles (clusters) selectively and to a high temperature (e.g. at least 100° C.) by a method of applying microwaves to a core-shell type fine particle raw material liquid containing core fine particles (clusters) made of a material having a dielectric constant of at least 10, and a precursor for a metal oxide. Therefore, even if the entire core-shell type fine particle raw material liquid becomes a high temperature (e.g. at least 100° C.), core fine particles are heated to a higher temperature, whereby hydrolytic condensation of the precursor for a metal oxide preferentially proceeds on the surface of core fine particles, whereby a metal oxide is selectively precipitated on the surface of core fine particles. Accordingly, the amount of particles made of a shell-forming material (a metal oxide) precipitated alone on other than the surface of core fine particles, can be suppressed. Further, the shell can be formed under a high temperature condition, whereby the shell can be formed in a short time. Further, the shell becomes denser, whereby the abrasion resistance of the obtainable water-repellent substrate will be improved, such being desirable.

Then, the obtained aggregates of the core-shell type fine particles are disintegrated to obtain aggregates of core-shell type fine particles (solid fine particles) having a desired volume average aggregate particle size, as the aggregates of the metal oxide fine particles (A) to be used in the present invention. As the disintegrating method, the same one as in the above-described method (2) may be used.

In a case where the aggregates of the metal oxide fine particles (A) to be used in the present invention are aggregates of hollow fine particles, a step of removing the core fine particle portion of the above obtained core-shell type fine particles (solid fine particles) is further carried out. The step of removing the core fine particles may be carried out either before or after the disintegration step.

The removal of core fine particles can be carried out by dissolving or decomposing the core fine particles in the core-shell type fine particles. As a method for dissolving or decomposing the core fine particles in the core-shell type fine particles, one or more methods selected from decomposition by heat, dissolution (decomposition) by an acid and decomposition by light, may be mentioned.

In a case where the core fine particles are made of a heat decomposable organic resin, such core fine particles may be removed by heating in a gas phase or a liquid phase. The heating temperature is preferably within a range of from 200 to 1,000° C. If it is lower than 200° C., the core fine particles are likely to remain, and if it exceeds 1,000° C., the metal oxide constituting the shell, such as silicon oxide, is likely to melt, such being undesirable.

In a case where the core fine particles are made of an acid-soluble inorganic compound, such core fine particles can be removed by adding an acid or an acidic cation exchange resin in a gas phase or a liquid phase.

In a case where the core fine particles are to be removed by dissolving them by an acid, such an acid may be an inorganic acid or an organic acid. The inorganic acid may, for example, be hydrochloric acid, sulfuric acid or nitric acid. The organic acid may, for example, be formic acid, acetic acid, propionic acid or oxalic acid. In such a case, ions formed by dissolution of the core fine particles may be removed by ultrafiltration.

Further, it is also preferred to employ an acidic cation exchange resin instead of a liquid acid or an acid solution. The acidic cation exchange resin is preferably a polyacrylic resin type or polymethacrylic resin type having a carboxylic acid group, particularly preferably a polystyrene type having a sulfonic acid group which is more strongly acidic. In such a case, after dissolving the core fine particles, the cation exchange resin is separated by solid-liquid separation such as filtration to obtain a dispersion liquid of hollow metal oxide fine particles, such as hollow silica fine particles. By the method of dissolving the core fine particles by adding an acid, it takes long time for removal by ultrafiltration of ions formed by dissolution of the core fine particles, and therefore, it is preferred to dissolve the core fine particles by means of the acidic cation exchange resin.

In a case where the core fine particles of the core-shell type fine particles are to be removed by using the acidic cation exchange resin, when hollow metal oxide fine particles are to be obtained by this operation, it is possible to control the volume average aggregate particle size of aggregates composed of such hollow metal oxide fine particles, by the time of stirring the metal oxide fine particles and the acidic cation exchange resin.

Further, in a case where the core fine particles are made of an inorganic compound soluble under irradiation with light, such core fine particles may be removed also by irradiation with light in a gas phase or in a liquid phase. The light is preferably an ultraviolet ray having a wavelength of at most 380 nm.

The aggregates of the metal oxide fine particles (A) to be used in the present invention are preferably aggregates having hollow metal oxide fine particles aggregated thus obtainable. Further, the aggregates of hollow metal oxide fine particles are particularly preferably aggregates of hollow metal oxide fine particles obtainable under irradiation with microwaves at the time of preparing aggregates of core-shell type fine particles. Further, it is preferred to use zinc oxide as the core fine particles. In a case where zinc oxide is used as the core fine particles and heating is carried out by microwaves, the core fine particles are selectively heated, whereby a dense shall can be formed, and the strength of the obtained undercoat layer will be increased, such being desirable. As the metal oxide constituting the shell of the hollow metal oxide fine particles is preferably silica (silicon oxide). Accordingly, the aggregates of the metal oxide fine particles (A) to be used in the present invention are preferably aggregates of hollow silica fine particles.

Further, the refractive index of the aggregates of the metal oxide fine particles (A) to be used in the present invention is the same as described in the water-repellent substrate of the present invention including preferred embodiments.

The content of the aggregates of the metal oxide fine particles (A) contained in the composition for formation of undercoat layer is preferably from 0.1 to 5 mass %, particularly preferably from 0.5 to 3 mass %, based on the entire amount of the composition for formation of undercoat layer. The reason is such that an undercoat layer thereby obtainable will have a proper concave-convex structure, whereby ultra-water-repellency is readily obtainable.

The total amount of the aggregates of the metal oxide fine particles (A) and the after-mentioned metal compound (B) contained in the composition for formation of undercoat layer is preferably from 0.1 to 10 mass %, more preferably from 0.5 to 10 mass %, particularly preferably from 1 to 5 mass %, based on the entire amount of the composition for formation of undercoat layer. When the solid content concentration is at least 0.1 mass %, it is possible to form an undercoat layer having a sufficient thickness to obtain ultra-water-repellency. When the solid content concentration is at most 10 mass %, it is possible to secure transparency as the thickness of the undercoat layer will not be too thick.

Further, in the production process of the present invention, the ratio of the aggregates of the metal oxide fine particles (A) to the metal oxide binder precursor i.e. the metal compound (B) contained in the composition for formation of undercoat layer is from 75:25 to 50:50 as the ratio of the aggregates of the metal oxide fine particles (A): the metal compound (B) by the mass ratio as calculated as metal oxides, and is preferably from 72:28 to 60:40. When the ratio of the aggregates of the metal oxide fine particles (A) to the metal compound (B) is within such a range, the concave-convex of the obtainable undercoat layer will be sufficient, and ultra-water-repellency of the water-repellent coating film surface reflecting it can be attained, and the strength of the undercoat layer is also sufficiently secured.

Here, the ratio of the aggregates of the metal oxide fine particles (A) to the metal compound (B) contained in the composition for formation of undercoat layer will be the ratio of the aggregates of the metal oxide fine particles (A) to the metal oxide binder in the undercoat layer as it is, by the mass ratio as calculated as metal oxides.

### (Metal Oxide Binder Precursor: Metal Compound (B))

Both of the composition (Ia) for formation of undercoat layer and the composition (Ib) for formation of undercoat layer to be used in the production process of the present invention contain a metal oxide binder precursor. The metal oxide binder precursor is a metal compound (hereinafter referred to simply as “metal compound (B)” which is converted to a metal oxide binder by a conventional reaction such as a hydrolytic condensation reaction or pyrolysis in the undercoat layer forming step.

The metal compound (B) is preferably a hydrolyzable metal compound having a hydrolyzable group bonded thereto, a partially hydrolyzed condensate of such a hydrolyzable metal compound or a metal coordination compound having a ligand coordinated. The hydrolyzable metal compound becomes a metal oxide by a hydrolytic condensation reaction, and the metal coordination compound becomes a metal oxide by pyrolysis. The metal atom is preferably at least one metal atom selected from the group consisting of a silicon atom, an aluminum atom, a titanium atom, a tin atom and a cerium atom, particularly preferably a silicon atom.

In a case where the metal compound is a hydrolysable metal compound, the hydrolyzable group may, for example, be an alkoxy group, an isocyanate group or a halogen atom, and it is preferably an alkoxy group. With the alkoxy group, the hydrolytic reaction and the condensation reaction proceed mildly. Further, in a case where the hydrolyzable group is an alkoxy group, such a metal compound (B) has a merit in that it is dispersed without aggregation in the after-mentioned composition for formation of undercoat layer, and will function sufficiently as a binder for the aggregates of the metal oxide fine particles (A) when formed into the undercoat layer. The alkoxy group may be a methoxy group, an ethoxy group or an isopropoxy group.

In a case where the metal compound (B) is a metal coordination compound, the ligand may, for example, be acetylacetate, acetylacetonate, ethylacetoacetate, lactate, or octylene glycolate.

In a case where the metal compound (B) is a hydrolyzable metal compound, it is preferred that at least two hydrolyzable groups are bonded to a metal atom. In a case where the metal compound (B) is a metal coordination compound, it is preferred that at least two ligands are coordinated to a metal atom. When at least two hydrolyzable groups are bonded (or at least two ligands are coordinated) to a metal atom, such a metal compound (B) becomes a strong binder when it is converted to a metal oxide binder.

In a case where the metal compound (B) is a hydrolyzable metal compound, to the metal atom in the metal compound (B), a group other than a hydrolyzable group may be bonded. As the group other than a hydrolyzable group, a monovalent organic group may be mentioned. The monovalent organic group may, for example, be an alkyl group; an alkyl group having a functional group such as a fluorine atom, a chlorine atom, an epoxy group, an amino group, an acyloxy group or a mercapto group; or an alkenyl group, and specifically, it is the same group as the after-mentioned R^{f}, R^{a}, R^{b} or R.

In a case where the metal compound (B) is a hydrolyzable metal compound, the metal compound (B) is preferably a hydrolyzable silicon compound wherein the metal atom is a silicon atom, or a partially hydrolyzed condensate of such a silicon compound. Specifically, at least one hydrolyzable silicon compound selected from the group consisting of the following compound (B-1), the following compound (B-2), the following compound (B-3) and the following compound (B-4), or a partially hydrolyzed condensate of such a hydrolyzable silicon compound, is preferred.

R^{a}—Si(R)ₘ(X¹)₍₃₋ₘ₎ (B-1)

R^{f}—Si(R)ₖ(X²)₍₃₋ₖ₎ (B-2)

R^{b}—Si(R)ₙ(X³)₍₃₋ₙ₎ (B-3)

Si(X⁴)₄ (B-4)

In the above formulae, the symbols have the following meanings.

R^{a}: a C₁₋₂₀ alkyl group or a C₂₋₆ alkenyl group.

R^{f}: a C₁₋₂₀ polyfluoroalkyl group.

R^{b}: a C₁₋₁₀ organic group having at least one functional group selected from the group consisting of an epoxy group, an amino group, an acyloxy group, a mercapto group and a chlorine atom.

R: a C₁₋₆ alkyl group, or a C₂₋₆ alkenyl group.

X¹, X², X³ and X⁴: each independently a halogen atom, a C₁₋₆ alkoxy group, a C₁₋₆ acyloxy group or an isocyanate group.

k, m and n: each independently 0 or 1.

In the above compound (B-1), when R^{a} is a C₁₋₂₀ alkyl group, the alkyl group may, for example, be a methyl group, an ethyl group, an isopropyl group, a t-butyl group, a n-hexyl group, a n-heptyl group, a n-octyl group, a n-nonyl group or a n-decyl group, preferably a methyl group, an ethyl group or an isopropyl group.

When R^{a} is a C₂₋₆ alkenyl group, it is preferably a C₂₋₄ linear alkenyl group. Specifically, the C₂₋₄ linear alkenyl group may, for example, be a vinyl group, an allyl group or a butenyl group, and is preferably a vinyl group or an allyl group.

In the above compound (B-2), R^{f} is a group corresponding to a C₁₋₂₀ alkyl group wherein at least two hydrogen atoms bonded to carbon atoms are substituted by fluorine atoms. R^{f} is particularly preferably a perfluoroalkyl group, wherein all hydrogen atoms are substituted by fluorine atoms. As R^{f}, a group represented by the following formula (B-5) is also preferred. Here, R^{f} preferably has from 1 to 10 carbon atoms.

F(CF₂)ₚ(CH₂)_{q}— (B-5)

In the above formula (B-5), p is an integer of from 1 to 8, q is an integer of from 2 to 4, and p+q is from 3 to 12, preferably from 6 to 11. As p, an integer of from 4 to 8 is preferred. As q, 2 or 3 is preferred.

The perfluoroalkyl group is preferably CF₃—, F(CF₂)₂—, F(CF₂)₃— or F(CF₂)₄—. The group represented by the formula (B-5) is preferably F(CF₂)₈ (CH₂)₂—, F(CF₂)₈ (CH₂)₃—, F(CF₂)₈ (CH₂)₂—, F(CF₂)₆ (CH₂)₃—, F(CF₂)₄ (CH₂)₂— or F(CF₂)₄ (CH₂)₃—.

In the above compounds (B-1) to (B-4), when X¹, X², X³ or X⁴ is a halogen atom, it is preferably a chlorine atom. Further, when X¹, X², X³ or X⁴ is a C₁₋₆ alkoxy group, each of them which are independent of one another, is preferably a methoxy group, an ethoxy group or an isopropoxy group. Further, when X¹, X², X³ or X⁴ is a C₁₋₆ acyloxy group, each of them which are independent of one another, is preferably an acetyloxy group or a propionyloxy group.

In the above compound (B-3), the functional group of R^{b} is preferably an epoxy group, an amino group or an acyloxy group. Further, when the functional group is an acyloxy group, it is preferably an acetoxy group, a propionyloxy group or a butyryloxy group. Here, “C₁₋₁₀” does not include the number of carbon atoms contained in the above functional group.

Each of k, m and n which are independent of one another, is 0 or 1. Each of k, m and n is preferably 0. When each of k, m and n is 0, the metal compounds (B-1) to (B-3) will have three hydrolyzable groups, whereby it is possible to firmly bond the metal compounds to one another or the metal compounds to the metal oxide fine particles, such being desirable.

Compound (B-1) may, for example, be specifically methyltriethoxysilane, methyltrimethoxysilane, ethyltriethoxysilane, dimethyldiethoxysilane, dimethyldimethoxysilane, ethenyldimethoxysilane, propenyldimethoxysilane, n-heptyltrimethoxysilane, n-heptyltriethoxysilane, n-octyltrimethoxysilane or n-octyltriethoxysilane.

Compound (B-2) may, for example, be specifically (3,3,3-trifluoropropyl)trimethoxysilane, (3,3,3-trifluoropropyl)methyldimethoxysilane, (3,3,3-trifluoromethyl)trimethoxysilane, (3,3,3-trifluoromethyl)methyldimethoxysilane, 3-(heptafluoroethyl)propyltrimethoxysilane, 3-(nonafluorohexyl)propyltrimethoxysilane, 3-(nonafluorohexyl)propyltriethoxysilane, 3-(tridecafluorooctyl)propyltrimethoxysilane, 3-(tridecafluorooctyl)propyltriethoxysilane or 3-(heptadecafluorodecyl)propyltrimethoxysilane.

Compound (B-3) may, for example, be specifically 3-glycidoxypropyltrimethoxysilane, 3-glycidoxypropylmethyldimethoxysilane, 3-aminopropyltrimethoxysilane, N-(2-aminoethyl)-3-aminopropyltrimethoxysilane or acetoxymethyltrimethoxysilane.

Compound (B-4) may, for example, be specifically tetraethoxysilane, tetramethoxysilane, tetraisopropoxysilane, tetraisocyanatesilane or tetrachlorosilane.

In the present invention, as the metal compound (B), among the compounds (B-1) to (B-4), an alkoxysilane compound is preferred, and an alkoxysilane compound wherein the hydrolyzable group of the compound (B-4) is an alkoxy group, or a partially hydrolyzed condensate of such compound (B-4) is more preferred. More specifically, tetraethoxysilane, a partially hydrolyzed condensate of tetraethoxysilane, tetramethoxysilane or a partially hydrolyzed condensate of tetramethoxysilane is preferred.

Further, as the metal compound (B), tetraisopropoxytitanium, tetrabutoxytitanium, triisopropoxyaluminum, tetrabutoxyzirconium or tetrapropoxyzirconium may also be suitably used.

In a case where the metal compound (B) is a metal coordination compound, it may, for example, be aluminum tris(acetyl acetate), aluminum (ethylacetoacetate)diisopropoxide, aluminum tris(ethylacetoacetate), titanium bis(acetyl acetate)diisopropoxide, titanium tetra(acetyl acetate), titanium bis(octylene glycolate)dibutoxide, titanium bis(lactate)dihydroxide, titanium bis(triethanolaminolate), titanium bis(ethylacetoacetate)diisopropoxide, polyhydroxytitanium stearate, zirconium (tetraacetyl acetate), zirconium (acetyl acetate)tributoxide, zirconium bis(acetyl acetate)dibutoxide or zirconium (acetyl acetate)(ethylacetoacetate)dibutoxide, preferably aluminum tris(acetyl acetate).

Further, when the metal compound (B) is a compound having fluorine atoms, there is a merit such that the chemical resistance or durability such as abrasion resistance is high.

The content of the metal compound (B) in the composition for formation of undercoat layer is as described above.

### (Aggregates of Metal Oxide Fine Particles (C))

The aggregates of metal oxide fine particles (C) which the above composition (Ib) for formation of undercoat layer further contains in addition to the aggregates of the metal oxide fine particles (A), are aggregates of metal oxide fine particles having a small average primary particle size as described in the above water-repellent substrate and undercoat layer of the present invention, specifically, an average primary particle size of from 3 to 18 nm, preferably from 3 to 10 nm, having smaller aggregation properties than the aggregates of the metal oxide fine particles (A), and having a volume average aggregate particle size of from 3 to 30 nm, preferably from 3 to 15 nm.

By the composition for formation of undercoat layer containing the aggregates of the metal oxide fine particles (C), gaps among the aggregates of the metal oxide fine particles can moderately be filled, thus increasing the mechanical strength and the heat resistance of the undercoat layer to be formed and reducing the shrinkage on curing of the layer at the time of the curing reaction.

The composition (Ib) for formation of undercoat layer contains the aggregates of the metal oxide fine particles (C) in a content of from 5 to 200 mass % based on the content of the aggregates of the metal oxide fine particles (A). If the composition for formation of undercoat layer contains the aggregates of the metal oxide fine particles (C) in a content exceeding 200 mass % based on the aggregates of the metal oxide fine particles (A), no sufficient concave-convex will be formed on the undercoat layer, and the above-mentioned ultra-water-repellency which the water-repellent substrate of the present invention has will not be attained. Further, the content of the aggregates of the metal oxide fine particles (C) is preferably within a range of from 5 to 100 mass %, more preferably from 10 to 90 mass %, based on the content of the aggregates of the metal oxide fine particles (A).

In the composition (Ib) for formation of undercoat layer, the ratio of the total content of the aggregates of the metal oxide fine particles (A) and the aggregates of the metal oxide fine particles (C) to the metal oxide binder precursor is from 90:10 to 50:50 by the mass ratio as calculated as metal oxides, and is preferably from 80:20 to 60:40. Further, in the composition (Ib) for formation of undercoat layer also, in the same manner as the composition (Ia) for formation of undercoat layer, the content ratio of the aggregates of the metal oxide fine particles (A) to the metal oxide binder precursor is from 75:25 to 50:50 by the mass ratio as calculated as metal oxides, and is preferably from 72:28 to 60:40.

The silica fine particles preferably used in the present invention as the metal oxide fine particles (C) may be blended to the composition for formation of undercoat layer as colloidal silica dispersed in water or in an organic solvent such as methanol, ethanol, isopropyl alcohol, isobutanol, propylene glycol monomethyl ether or butyl acetate. The colloidal silica may be either silica hydrosol dispersed in water or an organosilicasol having water replaced with an organic solvent, and either colloidal silica may be employed. Preferably, an organosilicasol employing, as a dispersing medium, the same organic solvent as an organic solvent preferably used for the composition for formation of undercoat layer, is used.

As the silica hydrosol or the organosilicasol, commercially available products may be employed, and the commercially available products may, for example, be SILICA HYDROSOL ST-OXS (tradename, manufactured by Nissan Chemical Industries, Ltd., average primary particle size: 5 nm, volume average aggregate particle size: 6 nm) wherein silica fine particles are dispersed in water in a ratio of 15 mass % as the silicon oxide content based on the entire amount of the silica hydrosol, ORGANOSILICASOL IPA-ST-S (tradename, manufactured by Nissan Chemical Industries, Ltd., average primary particle size: 9 nm, volume average aggregate particle size: 10 nm) wherein silica fine particles are dispersed in isopropyl alcohol in a ratio of from 30 to 45 mass % as the silicon oxide content based on the entire amount of the organosilicasol, ORGANOSILICASOL IPA-ST (tradename, manufactured by Nissan Chemical Industries, Ltd., average primary particle size: 15 nm, volume average aggregate particle size: 14 nm), and ORGANOSILICASOL NBAC-ST (tradename, manufactured by Nissan Chemical Industries, Ltd., average primary particle size: 15 nm, volume average aggregate particle size: 15 nm) wherein silica fine particles are dispersed in butyl acetate in a ratio of 30 mass % as the silicon oxide content based on the entire amount of the organosilicasol.

Further, in a case where colloidal silica is used as the silica fine particles, the amount of the solvent blended to the composition for formation of undercoat layer is properly adjusted considering the amount of the solvent contained in the colloidal silica.

Further, zirconia fine particles which are preferably used in the same manner as the silica fine particles in the present invention as the metal oxide fine particles (C), can also be blended to the composition for formation of undercoat layer in a state dispersed in water or an organic solvent, in the same manner as the colloidal silica. As the zirconia fine particle dispersion liquid having dispersed in water or in an organic solvent, commercially available products may be used. For example, ZSL-10T (tradename, manufactured by DAIICHI KIGENSO KAGAKU KOGYO CO., LTD., average primary particle size: 12 nm, volume average aggregate particle size: 23 nm) wherein zirconia fine particles are dispersed in a colloidal form in water in a ratio of 10 mass % as the content of zirconium oxide based on the entire amount of the sol, may be used.

### (Dispersing Medium)

As the dispersing medium in the composition for formation of undercoat layer, it is preferred to use the medium used for preparation of the aggregates of the metal oxide fine particles (A) as it is. Further, in a case where the composition for formation of undercoat layer contains aggregates of the metal oxide fine particles (C), it may further contain the medium used for preparation of the aggregates of the metal oxide fine particles (C) in addition.

As the medium used for preparation of the aggregates of the metal oxide fine particles (A), it is preferred to use, for example, a medium contained in the raw material liquid for preparation of the core-shell type fine particles, more specifically, a solvent to be used for formation of shell by hydrolytic condensation of the metal oxide precursor or the like, as it is. That is, in addition to water, an organic solvent such as an alcohol, a ketone, an ester, an ether, a glycol ether, a nitrogen-containing compound or a sulfur-containing compound may also be used. However, if desired, from such a solvent, e.g. water may be removed by such a means as azeotropic distillation to bring the solvent composed substantially solely of an organic solvent, or inversely, an organic solvent may be removed to bring the solvent composed of water or an aqueous solvent.

The composition for formation of undercoat layer may contain, in addition to the above components, as optional components as the case requires, additives such as a dispersing agent, a leveling agent, an ultraviolet absorber, a viscosity-controlling agent, an antioxidant and a surfactant. The dispersing agent may, for example, be acetylacetone or polyvinyl alcohol, preferably acetylacetone. Further, various pigments such as titania, zirconia, white lead and red iron oxide may be incorporated. The amount of such additives is preferably at most 10 mass % based on the total amount of the solid content contained in the composition for formation of undercoat layer.

(I-2) Formation of undercoat layer

In the production process of the present invention, the undercoat layer is formed by applying the composition for formation of undercoat layer containing the above respective components in the above blend ratio on the surface of the substrate, followed by drying.

As the method for applying the composition for formation of undercoat layer on the substrate surface, a known method such as roller coating, flexo coating, bar coating, die coating, gravure coating, roll coating, flow coating, spray coating, online spray coating, ultrasonic spray coating, inkjet coating or dip coating may be mentioned. The online spray coating is a method of carrying out spray coating on the line for forming the substrate, whereby a step of re-heating the substrate can be omitted, and the article can be produced at a low cost, such being useful. The composition for formation of undercoat layer is preferably applied in a thickness of from 10,000 to 30,000 nm (preferably in a thickness of from 15,000 to 25,000 nm) in a state containing a dispersing medium (in a wet state), although it may depend also on the solid content concentration.

Drying carried out after the above application, that is, removal of the dispersing medium, is preferably carried out by drying at a temperature of from room temperature (about 20° C.) to 700° C. after applying the composition for formation of undercoat layer on the substrate. By the removal of the dispersing medium, a layer containing the aggregates of the metal oxide fine particles (A) and the metal compound (B) to be the metal oxide binder precursor is formed on the substrate surface. And, in the process of drying the dispersing medium, the metal compound (B) is converted to a metal oxide binder, and an undercoat layer is formed. For formation of the undercoat layer, drying at a temperature of from room temperature to 700° C. is sufficient, but for the purpose of e.g. increasing the mechanical strength of the coating film, further heating may be carried out as the case requires.

The thickness (the thickness after drying) of the undercoat layer thus formed is usually from 45 to 590 nm, preferably from 75 to 390 nm, particularly preferably from 95 to 290 nm. When the thickness of the layer is at least 50 nm, if water droplets are dropped on the water-repellent coating film obtainable, a layer of air is partially formed between the water droplet and the undercoat layer surface, whereby ultra-water-repellency will be obtained. When the thickness of the layer is at most 590 nm, sufficient transparency can be secured. Here, the thickness of the undercoat layer is the average layer thickness measured and calculated in the same manner as measurement of the average thickness of the above water-repellent coating film.

On the surface of the undercoat layer formed as mentioned above, a concave-convex structure is formed derived from the shape of the aggregates of the metal oxide fine particles (A) contained in the undercoat layer. The concave-convex structure of the undercoat layer surface is preferably a concave-convex structure with an arithmetic mean roughness (Ra) preferably at a level of from 15 to 40 nm, more preferably at a level of from 20 to 30 nm. Further, the maximum peak-valley difference (P-V) of the concave-convex on the undercoat layer surface is preferably from 150 to 500 nm, more preferably from 200 to 400 nm. The water-repellent coating film surface which the water-repellent substrate of the present invention has reflects such a concave-convex structure of the undercoat layer surface, and it is considered that the concave-convex structure of the undercoat layer surface substantially determines the water-repellency of the obtainable water-repellent substrate surface. Accordingly, at the time of forming the undercoat layer, conditions are controlled so that the surface concave-convex structure is the above preferred structure.

Further, the porosity measured by the above method of the undercoat layer obtainable as mentioned above, is preferably at most 40%, more preferably at most 35%, so as to bring the porosity of the water-repellent coating film finally obtainable to be at most 30%. The porosity is particularly preferably 0%. The water-repellent coating film has more excellent abrasion resistance as the porosity is lower. The porosity of the undercoat layer can properly be adjusted by the after-mentioned treatment of filling a part or all of gaps in the interior of the layer by using a polysilazane.

(I-3) Undercoat Layer Reinforcing Treatment

As mentioned above, by applying the composition for formation of undercoat layer on the substrate, followed by drying, the metal compound (B) is cured, thereby to form an undercoat layer containing aggregates of the metal oxide fine particles (A). In the present invention, such an undercoat layer may be used as it is, or it is possible to use, as the undercoat layer, an undercoat layer obtainable in such a manner that gaps in the interior of the undercoat layer are impregnated with a composition containing a polysilazane, and a part or all of the gaps in the undercoat layer are filled with silicon oxide formed by hydrolytic condensation or pyrolysis of the polysilazane. The undercoat layer obtainable in such a manner is preferably used in the present invention as an undercoat layer having a decreased porosity of the undercoat layer obtainable by curing the composition for formation of undercoat layer and an increased hardness, and having improved abrasion resistance as a whole.

When the undercoat layer is impregnated with a composition containing a polysilazane to fill the gaps with silicon oxide formed by hydrolytic condensation or pyrolysis of the polysilazane, a silicon oxide coating film derived from the polysilazane may be formed on a part of the surface of the undercoat layer, but this coating film will not influence the concave-convex structure of the undercoat layer surface.

The polysilazane is a linear or cyclic compound having a structure represented by —SiR¹₂—NR²—SiR¹₂— (wherein each of R¹ and R² which are independent of each other, is hydrogen or a hydrocarbon group, and a plurality of R¹ may be different from one another). The polysilazane undergoes a reaction with moisture in the atmosphere, whereby the Si—NR²—Si bond will be decomposed to form a Si—O—Si network thereby to form silicon oxide. Such a hydrolytic condensation reaction is accelerated by heat, and usually, the polysilazane is heated and converted to silicon oxide. To accelerate the reaction, a catalyst such as a metal complex catalyst or an amine type catalyst may be used. As compared with silicon oxide formed from an alkoxysilane, the silicon oxide formed from a polysilazane has a dense structure and thus has high mechanical durability or gas barrier property.

Here, it is considered that the reaction to form silicon oxide from the polysilazane does not usually proceed completely by heating up to 300° C., and nitrogen remains in the form of a Si—N—Si bond or other bonds in the silicon oxide, and at least partially, silicon oxynitride is formed. The number average molecular weight of the polysilazane is preferably from about 500 to 5,000. The reason is such that when the number average molecular weight is at least 500, the silicon oxide-forming reaction tends to efficiently proceed, and on the other hand, when the number average molecular weight is at most 5,000, the number of cross-linked points in the silicon oxide network can be properly maintained, and it is possible to prevent formation of cracks or pinholes in the matrix.

In a case where the above R¹ or R² is a hydrocarbon group, it is preferably an alkyl group having at most 4 carbon atoms such as a methyl group or an ethyl group, or a phenyl group. In a case where R¹ is a hydrocarbon group, such a hydrocarbon group will remain on the silicon atom of silicon oxide to be formed. If the amount of such a hydrocarbon group bonded to the silicon atom increases in the silicon oxide, the property such as abrasion resistance is likely to deteriorate, and accordingly, the amount of the hydrocarbon group bonded to the silicon atom in the polysilazane is preferably small, and in a case where a polysilazane having a hydrocarbon group bonded to the silicon atom is to be used, it is preferred to use it in combination with a polysilazane having no hydrocarbon group bonded to the silicon atom.

A more preferably used polysilazane may, for example be a perhydropolysilazane of the above formula wherein R¹=R²=H, a partially organic polysilazane of the formula wherein R¹=a hydrocarbon group and R²=H, or a mixture thereof. In the polysilazane, the proportion of the number of silicon atoms to which hydrocarbon groups are bonded, is preferably at most 30%, particularly preferably at most 10%, based on all silicon atoms. A layer of silicon oxide formed by using such a polysilazane is very useful since the mechanical strength is high. A particularly preferred polysilazane is a perhydropolysilazane.

Further, the composition containing a polysilazane with which the undercoat layer is to be impregnated, may be a composition which contains at least the polysilazane and the solvent and which may contain, as other optional components, the same components as the optional components in the above composition for formation of undercoat layer. The solvent may, for example, be a hydrocarbon, an ester, an alcohol or an ether, preferably an ester. Specifically, it is preferably an acetate type solvent such as ethyl acetate, n-propyl acetate or n-butyl acetate, particularly preferably n-butyl acetate. The content of the polysilazane in this composition may be from 0.25 to 2.0 mass % as the amount of the polysilazane based on the entire amount of the composition, and is preferably from 0.5 to 1.5 mass %. The amount of the composition to be used to partially fill the gaps of the undercoat layer is an amount of the composition which can infiltrate into the undercoat layer. The impregnation method may, for example, be coating or dipping. Further, as the curing conditions, conditions at from 200 to 900° C. for from 0.1 to 1 hour may be mentioned as preferred conditions.

Further, by accelerating the curing of the polysilazane, it is possible to improve the abrasion resistance. For this purpose, it is preferred to further infiltrate an amine after infiltrating the polysilazane into the gaps of the undercoat layer. As such an amine, ammonia, methylamine, triethylamine or the like may be used, and their aqueous solutions may be used. However, it is not desirable that the amine will finally remain on the water-repellent substrate. Accordingly, preferred is an aqueous solution of methylamine which is readily volatilized as its boiling point is low.

(II) Water-Repellent Layer Forming Step

The water-repellent layer forming step is a step of applying a composition for formation of water-repellent layer on the surface of the undercoat layer, followed by drying to form a water-repellent layer on the surface of the undercoat layer. In a case where the water-repellent coating film which the water-repellent substrate of the present invention has, has another layer such as an adhesion layer between the undercoat layer and the water-repellent layer, the water-repellent substrate of the present invention can be produced by carrying out the same operation except that the composition for formation of water-repellent layer is applied “on the surface of another layer such as an adhesion layer” instead of “on the surface of the undercoat layer”. In the production process of the present invention, reflecting the concave-convex structure on the surface of the undercoat layer formed as mentioned above, the surface of the water-repellent layer is also formed to have a concave-convex structure, and this concave-convex structure contributes to the surface water-repellency.

The composition for formation of water-repellent layer to be used in the production process of the present invention contains a water-repellent agent and a solvent. The water-repellent agent contained in the composition for formation of water-repellent layer is preferably a silicone type water-repellent agent or a water-repellent agent containing a hydrophobic organic silicone compound, which is converted to a water-repellent material by a hydrolytic condensation reaction to constitute a water-repellent layer.

As the silicone type water-repellent agent, a linear silicone resin is preferred. Specifically, a linear dialkylpolysiloxane or alkylpolysiloxane may be used. Such a silicone resin may have hydroxyl groups at its terminals, or the terminals may be sealed with alkyl groups or alkenyl groups. Specifically, dimethylpolysiloxane having hydroxyl groups at both terminals, dimethylpolysiloxane having both terminals sealed with e.g. vinyl groups, methylhydrogen polysiloxane, alkoxy-modified dimethylpolysiloxane or fluoroalkyl-modified dimethyl silicone may, for example, be mentioned, and alkoxy-modified dimethylpolysiloxane is preferred.

By using such a silicone type water-repellent agent, the friction of the water-repellent coating film surface of the water-repellent substrate will be small, and such being effective for maintaining the concave-convex structure.

The hydrophobic organic silicon compound is preferably a compound having a silicon atom to which a hydrophobic organic group (bonded to the silicon atom by carbon-silicon bond) and a hydrolyzable group are bonded.

The hydrophobic organic group is preferably a monovalent hydrophobic organic group. Specifically, a monovalent hydrocarbon group or a monovalent fluorinated hydrocarbon group is preferred. The monovalent hydrocarbon group is preferably a C₁₋₂₀ alkyl group, particularly preferably a C₄₋₁₀ linear alkyl group. Specifically, a n-butyl group, a n-pentyl group, a n-hexyl group, a n-heptyl group or a n-octyl group may be mentioned, and a n-heptyl group or a n-octyl group is preferred. In addition, a C₃₋₁₀ cycloalkyl group is also preferred, and specifically, a cyclohexyl group is preferred.

The monovalent fluorinated hydrocarbon group is a group having at least one hydrogen atom contained in the above monovalent hydrocarbon group substituted by a fluorine atom, and a polyfluoroalkyl group is preferred.

The hydrolyzable group may, for example, be an alkoxy group, an isocyanate group, an acyloxy group or a halogen atom. The alkoxy group is preferably a methoxy group, an ethoxy group or an isopropoxy group. The acyloxy group is preferably an acetyloxy group or a propionyloxy group. The halogen atom is preferably a chlorine atom.

The hydrophobic organic silicon compound is preferably a compound represented by the following formula (1) (hereinafter sometimes referred to as compound (1)) or a compound represented by the following formula (2) (hereinafter sometimes referred to as compound (2)), particularly preferably a compound represented by the following formula (1).

R^{f1}—Si(R)ₛ(X¹¹)₍₃₋ₛ₎ (1)

R^{a1}—Si(R)ₜ(X²¹)₍₃₋ₜ₎ (2)

In the above formulae (1) and (2), the symbols have the following meanings.

R^{f1}: a C₁₋₁₂ polyfluoroalkyl group.

R^{a1}: a C₁₋₂₀ alkyl group or a C₃₋₁₀ cycloalkyl group.

R: a C₁₋₆ alkyl group or a C₁₋₆ alkenyl group.

X¹¹ and X²¹: each independently a halogen atom, a C₁₋₆ alkoxy group, a C₁₋₆ acyloxy group or an isocyanate group.

s and t: each independently 0 or 1.

In the above formula (1), R″ is a C₁₋₁₂ polyfluoroalkyl group. Such a polyfluoroalkyl group is preferably a group corresponding to an alkyl group wherein at least two hydrogen atoms bonded to carbon atoms are substituted by fluorine atoms, particularly preferably a perfluoroalkyl group having all hydrogen atoms substituted by fluorine atoms, or a group represented by the following formula (3).

F(CF₂)ᵥ(CH₂)_{w}— (3)

In the formula (3), v is an integer of from 1 to 8, preferably from 4 to 10. w is an integer of from 2 to 4, preferably 2 or 3. v+w is from 2 to 12, preferably from 61011.

The perfluoroalkyl group is preferably CF₃—, F(CF₂)₂—, F(CF₂— or F(CF₂)₄—, The group represented by the formula (3) is preferably F(CF₂)₈(CH₂)₂—, F(CF₂)₈(CH₂)₃—, F(CF₂)₆(CH₂)₂—, F(CF₂)₆(CH₂)₃—, F(CF₂)₄(CH₂)₂— or F(CF₂)₄(CH₂)₃—.

In the above formula (2), R^{a1} is a C₁₋₂₀ alkyl group or a C₃₋₁₀ cycloalkyl group. In a case where R^{a1} is a C₁₋₂₀ alkyl group, such a group preferably has a linear structure. Further, it preferably has from 4 to 10 carbon atoms. Specifically, a n-butyl group, a n-pentyl group, a n-hexyl group, a n-heptyl group or a n-octyl group may, for example, be mentioned, and a n-heptyl group or a n-octyl group is preferred. In a case where R^{a} is a C₃₋₁₀ cycloalkyl group, it is preferably a cyclohexyl group.

In the above formulae (1) and (2), R is each independently a C₁₋₆ alkyl group or a C₁₋₆ alkenyl group. Such a group preferably has a linear structure. The C₁₋₆ alkyl group is preferably a methyl group, an ethyl group, a n-propyl group, a n-butyl group, a n-pentyl group or a n-hexyl group. The alkenyl group having at most 6 carbon atoms may, for example, be a propenyl group or a butenyl group.

In the above formulae (1) and (2), each of X¹¹ and X²¹ which are independent of each other, is a halogen atom, a C₁₋₆ alkoxy group, a C₁₋₆ acyloxy group or an isocyanate group. The halogen atom is preferably a chlorine atom. The C₁₋₆ alkoxy group preferably has a linear structure and preferably has from 1 to 3 carbon atoms. In a case where X¹¹ or X²¹ is a C₁₋₆ acyloxy group, it may, for example, be an acetyloxy group or a propionyloxy group, preferably an acetyloxy group.

Specifically, the following compounds may be mentioned as the compound (1).

F(CF₂)ₑSi(NCO)₃, F(CF₂)_{f}Si(Cl)₃, F(CF₂)_{g}Si(OCH₃)_{g} (wherein each of e, f and g which are independent of one another, is an integer of from 1 to 4.)

More specifically, the following compounds may be mentioned.

(CF₂)₈(CH₂)₂Si(NCO)₃, F(CF₂)₈(CH₂)₂Si(Cl)₃, F(CF₂)₈(CH₂)₂Si(OCH₃)₃, F(CF₂)₆(CH₂)₂Si(NCO)₃, F(CF₂)₆(CH₂)₂Si(Cl)₃, F(CF₂)₆(CH₂)₂Si(OCH₃)₃, F(CF₂)₄(CH₂)₂Si(NCO)₃, F(CF₂)₄(CH₂)₂Si(Cl)₃, F(CF₂)₄(CH₂)₂Si(OCH₃)₃.

Among them, F(CF₂)₈(CH₂)₂Si(NCO)₃, F(CF₂)₈(CH₂)₂Si(Cl)₃ or F(CF₂)₈(CH₂)₂Si(OCH₃)₃ is preferred.

The compound (2) may, for example, be methyltrimethoxysilane, methyltriethoxysilane, ethyltriethoxysilane, dimethyldiethoxysilane, dimethyldimethoxysilane, trimethylmethoxysilane, trimethylethoxysilane, triethylmethoxysilane, triethylethoxysilane, n-decyltrimethoxysilane, n-decyltriethoxysilane, cyclohexyltrimethoxysilane or cyclohexyltriethoxysilane. Among them, dimethyldimethoxysilane, n-decyltrimethoxysilane or cyclohexyltrimethoxysilane is preferred.

The above compound (1) or (2) may be used alone or may be a partially hydrolyzed condensate of at least one compound selected from the above-mentioned group of compounds.

Further, the water-repellent layer may be formed from a water-repellent agent containing a compound represented by the following formula (4), other than the above compound (1) or (2), so long as the water-repellency will not be impaired.

Si(X⁴¹)₄ (4)

In the formula (4), X⁴¹ represents a hydrolyzable group and is the same group as the above X¹¹ or X²¹, and its preferred embodiments are also the same. The compound represented by the formula (4) is preferably tetraisocyanatesilane or tetraalkoxysilane.

The solvent in the composition for formation of water-repellent layer may, for example, be a hydrocarbon, an ester, an alcohol or an ether, preferably an ester. Specifically, an acetic acid ester type solvent such as ethyl acetate, n-propyl acetate or n-butyl acetate is preferred, and n-butyl acetate is particularly preferred. Further, to the composition for formation of water-repellent layer, other components may be added as the case requires. As such other components, for example, a catalyst (e.g. an acid such as hydrochloric acid or nitric acid) for the hydrolytic condensation reaction of the water-repellent agent may be mentioned.

As the method of applying the composition for formation of water-repellent layer on the surface of the undercoat layer, the same method as the method of applying the composition for formation of undercoat layer on the surface of the substrate may be mentioned, and the preferred method is also the same. “Drying” which is a step including removal of the solvent carried out after application, and as the case requires, hydrolytic condensation reaction, may be carried out by maintaining the article after applying the composition for formation of water-repellent layer, for example, at a temperature of from room temperature to 200° C. for from 10 to 60 minutes.

In a case where a compound having a reactivity such as the above compound (1) or (2) is used as the water-repellent agent, a hydrolytic reaction, a condensation reaction, etc. of such a compound proceeds at the surface of the undercoat layer to form a water-repellent layer made of the water-repellent material which covers substantially the entirety of the surface of the undercoat layer. Depending upon the type of the water-repellent agent, formation of the water-repellent layer, that is, a hydrolytic condensation reaction, a condensation reaction, etc. of the water-repellent agent may proceed at the same time as the removal of the solvent, and there may be a case where heating is required. In a case where heating is required, heating is preferably carried out at a temperature of from 60 to 200° C. for from 10 to 60 minutes.

The thickness of the water-repellent layer formed by the above method is preferably from 1 to 10 nm, more preferably from 2 to 5 nm. The water-repellent layer formed on the undercoat layer is a very thin layer, whereby the three dimensional shape of the water-repellent layer surface reflects the three dimensional shape of the undercoat layer surface and thus has a similar shape.

Here, when the water-repellent layer is directly formed on the surface of the undercoat layer, the water-repellent material contained in the water-repellent layer is bonded at least to the convex upper surface of the undercoat layer and may be bonded to portions (portions other than the convex upper surface) such as concaves or spaces in the undercoat layer formed derived from the shape of the aggregates of the metal oxide fine particles (A). In a case where the water-repellent material is deposited not only on the convex upper surface of the undercoat layer but also in the concaves or spaces in the undercoat layer, even if the water-repellency on the convex upper surface of the water-repellent article is lowered by the abrasion during the use, the water-repellent performance can be maintained by the water-repellent material present at the portions such as concaves or spaces in the undercoat layer, such being desirable.

In such a manner, according to the production process of the present invention, the water-repellent substrate of the present invention comprising, on at least one side of a substrate, a water-repellent coating film comprising an undercoat layer and a water-repellent layer from the substrate side, can be obtained.

Here, in the process for producing a water-repellent substrate of the present invention, the thickness of the obtainable water-repellent coating film, i.e. the total thickness of the undercoat layer and the water-repellent layer, is adjusted to be from 50 to 600 nm as the average thickness measured by the above measurement method. By adjusting the average thickness of the water-repellent coating film in the water-repellent substrate to be within such a range, the water-repellent substrate of the present invention having the above-mentioned ultra-water-repellency can be obtained. The average thickness of the water-repellent coating film is preferably from 80 to 400 nm. The surface of the water-repellent coating film which the water-repellent substrate of the present invention has, has the concave-convex structure derived from the aggregates of the metal oxide fine particles (A). The arithmetic mean roughness (Ra) of the surface of the water-repellent coating film is preferably from 15 to 40 nm, more preferably from 20 to 30 nm.

Further, the maximum peak-valley difference (P-V) of the concave-convex on the surface of the water-repellent coating film is preferably from 150 to 500 nm, more preferably from 250 to 450 nm. By such a surface structure, the water-repellent coating film which the water-repellent substrate of the present invention has, has the water-repellent performance with the above water splash property of at least 100 mm. Further, the water-repellent coating film which the water-repellent substrate of the present invention has, preferably has a water contact angle on the coating film surface of at least 130°, more preferably at least 135°.

Further, the porosity of the water-repellent coating film of the water-repellent substrate of the present invention measured by the above method is at most 30%, preferably at most 25%, more preferably at most 20%. The water-repellent coating film having a porosity of at most 30% is excellent in the abrasion resistance, and even after an abrasion test for 2,000 reciprocations by means of a traverse tester at a stress of 11.8 N/4 cm² using a flannel cloth in accordance with JIS L0803, it maintains the water-repellent performance and has the above water splash property of the surface of the water-repellent coating film of at least 20 mm. Further, the water contact angle on the surface of the water-repellent coating film after the above abrasion resistance test is preferably at least 100°, more preferably at least 110°, particularly preferably at least 120°.

The water-repellent coating film which the water-repellent substrate of the present invention has may have various functional layers between the undercoat layer and the water-repellent layer within a range not to impair the effects of the present invention. Such functional layers may, for example, be an adhesion layer to improve the adhesion between the undercoat layer and the water-repellent layer.

(I)′ Adhesion Layer Forming Step

The adhesion layer which the water-repellent coating film of the present invention optionally has, is preferably formed by applying a composition for formation of adhesion layer containing an adhesion-improving component and a solvent on the surface of the undercoat layer on the substrate having the undercoat layer formed thereon, and removing the solvent. Depending on e.g. the type of the silicon compound to be used as the adhesion-improving component, after removal of the solvent, heating may be carried out as the case requires.

The adhesion-improving agent is preferably a silicon compound other than the polysilazane (e.g. a silicon compound having a hydrolyzable group such as an alkoxy group, an isocyanate group or a halogen atom bonded to a silicon atom). Specifically, it is preferably a silicon oxide layer formed from at least one silicon compound selected from the group consisting of alkoxysilanes such as a tetraalkoxysilane or its oligomer, and an organotrialkoxysilane or its oligomer; chlorosilanes such as an organotrichlorosilane or its oligomer; and an isocyanatesilane.

As the solvent in the composition for formation of adhesion layer, in addition to water, an organic solvent such as an alcohol, a ketone, an ester, an ether, a glycol ether, a nitrogen-containing compound or a sulfur-containing compound may be used. However, if desired, from such a solvent, e.g. water may be removed by such a means as azeotropic distillation to bring the solvent composed substantially solely of an organic solvent, or inversely, an organic solvent may be removed to bring the solvent composed of water or an aqueous solvent. Further, to the composition for formation of adhesion layer, another component may be added as the case requires. Such another component may, for example, be a catalyst (such as an acid such as hydrochloric acid or nitric acid) for the hydrolytic condensation reaction of the silicon compound.

As a method of applying the composition for formation of adhesion layer on the surface of the undercoat layer, the same method as the method of applying the composition for formation of undercoat layer on the surface of the substrate may be mentioned, and the preferred method is also the same. Removal of the solvent can be carried out by holding an article after applying the composition for formation of adhesion layer, at from room temperature to 200° C. for from 10 to 60 minutes.

The thickness of the adhesion layer thus formed is preferably from 1 to 10 nm, more preferably from 2 to 5 nm. Further, reflecting the concave-convex structure of the undercoat layer, the surface of the adhesion layer obtainable as mentioned above has a similar concave-convex structure.

Here, the water-repellent layer and the adhesion layer, and other functional layers provided as the case requires, may not necessarily cover the entirety of the surface of the layer located thereunder. That is, so long as the function of each layer is sufficiently obtained, there may be a partial portion where such a layer is not formed.

### <Article for Transport Machine>

The water-repellent substrate having the water-repellent coating film of the present invention has a high water splash property of the surface of the water-repellent coating film, i.e. excellent water-repellency, and can maintain a state with a high water splash property (excellent in the water-repellency) even after a certain abrasion resistance test. Accordingly, the water-repellent substrate of the present invention is useful for an article for a transport machine such as a window glass for a transport machine (such as an automobile, a train, a ship or an airplane) and is particularly useful for a window glass such as a window glass for a windshield, a window glass for a side window or a window glass for a rear window for an automobile. As a window glass for an automobile, it may be a single plate glass or a laminated glass. In a case where the water-repellent substrate of the present invention is used for a laminated glass, it is preferred to employ a method of laminating the water-repellent substrate produced by the above-described method, an interlayer and another substrate in this order, followed by press bonding.

In a case where the water-repellent substrate of the present invention is to be used for an article for a transport machine, particularly a window glass, such a water-repellent substrate is preferably transparent. Specifically, its haze value is preferably at most 10%, more preferably at most 5%, further preferably at most 2%.

### EXAMPLES

Now, the present invention will be described in detail with reference to Examples, but it should be understood that the present invention is by no means restricted to such Examples. Examples 1 to 31 are Examples of the present invention, and Examples 32 to 43 are Comparative Examples.

### <Composition for Formation of Undercoat Layer>

### [1] Preparation of Composition Containing Metal Compound (B) to be Precursor for Metal Oxide Binder (Hereinafter Referred to as “Binder Composition”)

### [1-1] Preparation of Binder Composition (1)

To ethanol (86.7 g), tetraethoxysilane (5.2 g), methyltriethoxysilane (3.0 g) and a 1.2 mass % nitric acid aqueous solution (5.1 g) were added and stirred for one hour to subject tetraethoxysilane and methyltriethoxysilane to a hydrolytic condensation reaction to obtain a silicic acid oligomer solution (solid content concentration as calculated as silicon oxide: 2.5 mass %) as binder composition (1).

### [1-2] Preparation of Binder Composition (2)

To ethanol (86.2 g), tetraethoxysilane (8.7 g) and a 1.2 mass % nitric acid aqueous solution (5.1 g) were added and stirred for one hour to subject tetraethoxysilane to a hydrolytic condensation reaction to obtain a silicic acid oligomer solution (solid content concentration as calculated as silicon oxide: 2.5 mass %) as binder composition (2).

### [2] Preparation of Dispersion Liquid of Aggregates of Metal Oxide Fine Particles (A) (Hereinafter Referred to as “Aggregate Dispersion Liquid”)

### [2-1] Preparation of Aggregate Dispersion Liquid (1)

Using a rotary evaporator, a dispersing medium was removed from a dispersion liquid of alumina fine particles (manufactured by Nissan Chemical Industries, Ltd., ALUMINASOL 100, average primary particle size: 55 nm) at 60° C. to obtain powdery solid alumina fine particles (aggregates of alumina fine particles). Then, into a 200 mL alumina container, the above aggregates (2 g) of alumina fine particles, ethanol (48 g), 50 g of pure water and alumina balls (diameter: 0.5 mm, 10 g) were added and stirred for one hour, and then the alumina balls were removed by filtration to obtain aggregate dispersion liquid (1). Of this alumina fine particle dispersion liquid, the volume average aggregate particle size was 505 nm, and the solid content concentration was 2 mass %.

Here, by removing the dispersing medium from the dispersion liquid of the raw material alumina fine particles, the alumina fine particles form aggregates, and by stirring the aggregates together with the alumina balls, aggregates having the above desired volume average aggregate particle size can be obtained.

### [2-2] Preparation of Aggregate Dispersion Liquid (2)

Aggregate dispersion liquid (2) was prepared in the same manner as in the above [2-1] except that a zirconia fine particle dispersion liquid (manufactured by DAIICHI KIGENSO KAGAKU KOGYO CO., LTD. ZSL-20N, average primary particle size: 70 nm) was used instead of the alumina fine particle dispersion liquid. Of the solid zirconia fine particle dispersion liquid, the volume average aggregate particle size was 430 nm, and the solid content concentration was 2 mass %.

### [2-3] Preparation of Aggregate Dispersion Liquid (3)

Aggregate dispersion liquid (3) was prepared in the same manner as in the above [2-1] except that a silica fine particle dispersion liquid (manufactured by Nissan Chemical Industries, Ltd. ST-L, average primary particle size: 50 nm) was used instead of the alumina fine particle dispersion liquid. Of the solid silica fine particle dispersion liquid, the volume average aggregate particle size was 220 nm, and the solid content concentration was 2 mass %.

### [2-4] Preparation of Aggregate Dispersion Liquid (4)

Into a 80 mL quartz pressure resistant container, ethanol (7.17 g), a zinc oxide aqueous dispersion liquid (average primary particle size: about 25 nm, solid content concentration: 20 mass %) (10 g), aluminum acetylacetonate (2.7 g) and 28 mass % aqueous ammonia (0.13 g) were introduced and mixed to prepare a raw material liquid.

After sealing the pressure resistant container, using a microwave heating apparatus with a maximum output power of 1,400 W, the raw material liquid was irradiated for 5 minutes with microwaves with a frequency of 2.45 GHz with such an output power that the raw material liquid was heated to 200° C. By this operation, a dispersion liquid of core-shell type fine particles wherein the core was made of zinc oxide, and the shell was made of alumina, was obtained.

To this dispersion liquid (19 g) of core-shell type fine particles, 20 g of a strongly acidic cation exchange resin (DIAION manufactured by Mitsubishi Chemical Corporation, total exchange capacity: at least 2.0 meq/mL) was added and stirred for 6 hours to dissolve zinc oxide as the core, and then the strongly acidic cation exchange resin was removed by filtration to obtain dispersion liquid (4) of aggregates of hollow alumina fine particles. Of the hollow alumina fine particle dispersion liquid, the average primary particle size was 37 nm, the volume average aggregate particle size was 510 nm, the shell thickness was 5.5 nm, and the solid content concentration was 4.2 mass %.

### [2-5] Preparation of Aggregate Dispersion Liquid (5)

Into a 80 mL quartz pressure resistant container, ethanol (4.87 g), a zinc oxide aqueous dispersion liquid (average primary particle size: about 25 nm, solid content concentration: 20 mass %) (10 g), zirconium acetylacetonate (5.0 g) and 28 mass % aqueous ammonia (0.13 g) were introduced and mixed to prepare a raw material liquid.

After sealing the pressure resistant container, using a microwave heating apparatus with a maximum output power of 1,400 W, the raw material liquid was irradiated for 5 minutes with microwaves with a frequency of 2.45 GHz with such an output power that the raw material liquid was heated to 200° C. By this operation, a dispersion liquid of core-shell type fine particles wherein the core was made of zinc oxide, and the shell was made of zirconia, was obtained.

To this dispersion liquid (19 g) of core-shell type fine particles, 20 g of a strongly acidic cation exchange resin (DIAION manufactured by Mitsubishi Chemical Corporation, total exchange capacity: at least 2.0 meq/mL) was added and stirred for 6 hours, and then the strongly acidic cation exchange resin was removed by filtration to obtain dispersion liquid (5) of aggregates of hollow zirconia fine particles. Of the hollow zirconia fine particle dispersion liquid, the average primary particle size was 37 nm, the volume average aggregate particle size was 420 nm, the shell thickness was 5.5 nm, and the solid content concentration was 6.3 mass %.

### [2-6] Preparation of Aggregate Dispersion Liquid (6)

Into a 80 mL quartz pressure resistant container, ethanol (8.21 g), a zinc oxide aqueous dispersion liquid (average primary particle size: about 25 nm, solid content concentration: 20 mass %) (10 g), aluminum acetylacetonate (0.07 g), 28 mass % aqueous ammonia (0.13 g) and tetraethoxysilane (1.59 g) were introduced and mixed to prepare a raw material liquid.

After sealing the pressure resistant container, using a microwave heating apparatus with a maximum output power of 1,400 W, the raw material liquid was irradiated for 3 minutes with microwaves with a frequency of 2.45 GHz with such an output power that the raw material liquid was heated to 150° C. By this operation, a dispersion liquid of core-shell type fine particles wherein the core was made of zinc oxide, and the shell was made of silica, was obtained.

To this dispersion liquid (19 g) of core-shell type fine particles, 20 g of a strongly acidic cation exchange resin (DIAION manufactured by Mitsubishi Chemical Corporation, total exchange capacity: at least 2.0 meq/mL) was added and stirred for 6 hours, and then the strongly acidic cation exchange resin was removed by filtration to obtain dispersion liquid (6) of aggregates of hollow silica fine particles. Of the hollow silica fine particle dispersion liquid, the average primary particle size was 35 nm, the volume average aggregate particle size was 395 nm, the shell thickness was 4.5 nm, and the solid content concentration was 2.3 mass %.

The volume average aggregate particle size was controlled by the time of stirring with the strongly acidic cation exchange resin. In a case where the shell thickness was 10 nm, the zinc oxide core fine particles were not dissolved even when the pH was 4.

### [2-7] Preparation of Aggregate Dispersion Liquid (7)

Dispersion liquid (7) of aggregates of hollow silica fine particles was obtained in the same manner as the preparation of aggregate dispersion liquid (6) except that a zinc oxide aqueous dispersion having an average primary particle size of 15 nm was used. Of the hollow silica fine particle dispersion liquid, the average primary particle size was 20 nm, the volume average aggregate particle size was 356 nm, the shell thickness was 1.5 nm, and the solid content concentration was 2.3 mass %.

### [2-8] Preparation of Aggregate Dispersion Liquid (8)

Dispersion liquid (8) of aggregates of hollow silica fine particles was obtained in the same manner as the preparation of aggregate dispersion liquid (6) except that a zinc oxide aqueous dispersion having an average primary particle size of 60 nm was used. Of the hollow silica fine particle dispersion liquid, the average primary particle size was 75 nm, the volume average aggregate particle size was 420 nm, the shell thickness was 7 nm, and the solid content concentration was 2.3 mass %.

### [2-9] Preparation of Aggregate Dispersion Liquid (9)

Dispersion liquid (9) of aggregates of hollow silica fine particles was obtained in the same manner as the preparation of aggregate dispersion liquid (6) except that a zinc oxide aqueous dispersion having an average primary particle size of 70 nm was used. Of the hollow silica fine particle dispersion liquid, the average primary particle size was 90 nm, the volume average aggregate particle size was 410 nm, the shell thickness was 8 nm, and the solid content concentration was 2.3 mass %.

### [2-10] Preparation of Aggregate Dispersion Liquid (10)

Dispersion liquid (10) of aggregates of hollow silica fine particles was obtained in the same manner as the preparation of aggregate dispersion liquid (6) except that after the strongly acidic cation exchange resin was added, the dispersion liquid was stirred for 12 hours. Of the hollow silica fine particles, the average primary particle size was 40 nm, the volume average aggregate particle size was 170 nm, the average shell thickness was 4.5 nm, and the solid content concentration was 2.3 mass %.

### [2-11] Preparation of Aggregate Dispersion Liquid (11)

Dispersion liquid (11) of aggregates of hollow silica fine particles was obtained in the same manner as the preparation of aggregate dispersion liquid (6) except that after the strongly acidic cation exchange resin was added, the dispersion liquid was stirred for 10 hours. Of the hollow silica fine particles, the average primary particle size was 35 nm, the volume average aggregate particle size was 240 nm, the average shell thickness was 4.5 nm, and the solid content concentration was 2.3 mass %.

### [2-12] Preparation of Aggregate Dispersion Liquid (12)

Dispersion liquid (12) of aggregates of hollow silica fine particles was obtained in the same manner as the preparation of aggregate dispersion liquid (6) except that after the strongly acidic cation exchange resin was added, the dispersion liquid was stirred for 3 hours. Of the hollow silica fine particles, the average primary particle size was 35 nm, the volume average aggregate particle size was 580 nm, the average shell thickness was 4.5 nm, and the solid content concentration was 2.3 mass %.

### [2-13] Preparation of Aggregate Dispersion Liquid (13)

Dispersion liquid (13) of aggregates of hollow silica fine particles was obtained in the same manner as the preparation of aggregate dispersion liquid (6) except that after the strongly acidic cation exchange resin was added, the dispersion liquid was stirred for 1 hour. Of the hollow silica fine particles, the average primary particle size was 35 nm, the volume average aggregate particle size was 720 nm, the average shell thickness was 4.5 nm, and the solid content concentration was 2.3 mass %.

### [3] Preparation of Composition for Formation of Undercoat Layer

Preparation of the composition for formation of undercoat layer (hereinafter referred to as “composition for formation of undercoat layer”) was carried out by mixing 2-propanol, any one of the binder compositions prepared in the above [1] and any one of the aggregate dispersion liquids prepared in the above [2] (in some Examples, to which the following metal oxide fine particle (C) dispersion liquid was added in each amount) in addition amounts described in each Example.

### (Metal Oxide Fine Particle (C) Dispersion Liquid)

ST-OXS (tradename, manufactured by Nissan Chemical Industries, Ltd., metal oxide: silicon oxide, average primary particle size: 5 nm, volume average aggregate particle size: 6 nm, dispersing medium: water, concentration: 15 mass %),

IPA-ST-S (tradename, manufactured by Nissan Chemical Industries, Ltd., metal oxide: silicon oxide, average primary particle size: 9 nm, volume average aggregate particle size: 10 nm, dispersing medium: isopropyl alcohol, concentration: 0.30 mass %),

IPA-ST (tradename, manufactured by Nissan Chemical Industries, Ltd., metal oxide: silicon oxide, average primary particle size: 15 nm, volume average aggregate particle size: 14 nm, dispersing medium: isopropyl alcohol, concentration: 30 mass %),

IPA-ST-L (tradename, manufactured by Nissan Chemical Industries, Ltd., metal oxide: silicon oxide, average primary particle size: 45 nm, volume average aggregate particle size: 43 nm, dispersing medium: isopropyl alcohol, concentration: 30 mass %).

ZSL-10T (tradename, manufactured by DAIICHI KIGENSO KAGAKU KOGYO CO., LTD., metal oxide: zirconium oxide, average primary particle size: 12 nm, volume average aggregate particle size: 23 nm, dispersing medium: water, concentration: 10 mass %), ZSL-20NT (tradename, manufactured by DAIICHI KIGENSO KAGAKU KOGYO CO., LTD., metal oxide: zirconium oxide, average primary particle size: 70 nm, volume average aggregate particle size: 72 nm, dispersing medium: water, concentration: 10 mass %).

The concentration (mass %) described in the above dispersion liquid means a content of each metal oxide in the dispersion liquid.

### [4] Preparation of Composition for Undercoat Layer Reinforcing Treatment

Perhydropolysilazane (AQUAMICA NP110: tradename, AZ Electronic Materials, concentration: 20 mass %) was diluted with butylacetate to a concentration as described in each Example to obtain a composition for undercoat layer reinforcing treatment.

### [5] Preparation of Composition for Undercoat Layer Reinforcing Treatment

A methylamine aqueous solution (concentration: 40 mass %) was diluted two fold with ethanol to obtain a composition for undercoat layer reinforcing treatment.

### [6] Preparation of Composition for Formation of Adhesion Layer

Isocyanatesilane (SI-400, tradename, manufactured by Matsumoto Fine Chemical Co., Ltd.) was diluted 200 fold with butyl acetate to obtain a composition for formation of adhesion layer (hereinafter referred to as “composition for formation of adhesion layer”).

### [7] Preparation of Composition for Formation of Water-Repellent Layer

F(CF₂)₈(CH₂)₂Si(OCH₃)₃ (3.37 g) was dissolved in 2-propanol (95.63 g), a 0.8 mass % nitric acid aqueous solution (1 g) was added, followed by stirring for 5 hours, and 3.33 g of the obtained liquid was collected and mixed with ethanol (14.67 g) and ethyl lactate (2.0 g) to obtain a composition for formation of water-repellent layer (hereinafter referred to as “composition for formation of water-repellent layer”).

### [8] Method of Application/Drying of Each Composition in Formation of Water-Repellent Coating Film

On the surface of a glass substrate (100 mm×100 mm) which was cleaned by abrasion with cerium oxide and then well dried by air blowing, the above-prepared [3] composition for formation of undercoat layer, [4] composition for undercoat layer reinforcing treatment, [5] composition for undercoat layer reinforcing treatment, [6] composition for formation of adhesion layer and [7] composition for formation of water-repellent layer were applied in this order under the following coating conditions, followed by drying under the after-mentioned conditions for the respective layers to form a water-repellent coating film on the substrate.

In some Examples, application/drying of [4] composition for undercoat layer tempering treatment, [5] composition for undercoat layer reinforcing treatment or [6] composition for formation of adhesion layer was not carried out, however, the compositions were applied in the above order except for the composition not applied.

On the surface of the substrate or a layer to be located thereunder, about 2 g of each composition was dropped and applied by spin coating (number of revolutions: 500 rpm, 20 seconds). As the drying/heating conditions, with respect to [3] composition for formation of undercoat layer, [4] composition for undercoat layer reinforcing treatment and [6] composition for formation of adhesion layer, the composition was dried in the air for about 5 minutes and then the next composition was applied. With respect to [5] composition for undercoat layer reinforcing treatment, the composition was dried in the air for about 5 minutes, heated at 200° C. for 10 minutes and then cooled to room temperature, and then the next composition was applied. With respect to [7] composition for formation of undercoat layer, it was left to stand in the air for one day after application, and then the excessive water-repellent agent was washed away with ethanol.

### [9] Method of Measurement/Evaluation

Evaluation of physical properties of fine particles/aggregates used for the above respective compositions and water-repellent coating films obtained in the respective Examples was carried out by the following methods.

### <Physical Properties of Metal Oxide Fine Particles/Aggregates>

### 1. Average Primary Particle Size

Metal oxide fine particles were observed by a transmission type electron microscope (H-9000 manufactured by Hitachi Ltd.), whereby 100 particles were randomly selected, the particle sizes of the respective metal oxide fine particles were measured, and their averaged value by volume was taken as the average primary particle size.

### 2. Volume Average Aggregate Particle Size

With respect to the volume average aggregate particle size of metal oxide fine particles, measurement was carried out by a dynamic light scattering particle size analyzer (MICROTRAC UPA manufactured by NIKKISO CO., LTD.), and a D50 value by volume distribution was taken as the volume average aggregate particle size. As the measuring conditions, measurement was carried out by employing the refractive index of the dispersed component, and the refractive index and the viscosity of the main solvent. The aggregate dispersion liquid prepared in [2] was diluted three fold with pure water, and employing the refractive index and the viscosity of water as the refractive index and the viscosity of the main solvent, measurement was carried out. With respect to the hollow fine particles, measurement was carried out by employing the refractive index of the shell component as the refractive index of the dispersed component.

### 3. Average Shell Thickness (Hollow Fine Particles)

Hollow fine particles were observed by a transmission type electron microscope (H-9000, manufactured by Hitachi Ltd.), whereby 100 particles were randomly selected, the average shell thicknesses were measured, and their averaged value was taken as the shell thickness.

### <Physical Properties of Water-Repellent Coating Film>

### 4. Film Thickness

In an image of the cross section of the substrate having the water-repellent coating film formed thereon, photographed by a scanning electron microscope (S-4500 model, manufactured by Hitachi Ltd., measuring conditions: accelerating voltage of 15 kV and emission current of 5 μA) with 50,000 magnifications, the thickness from the substrate surface to the surface of the water-repellent coating film when the cross section was projected at right angles was measured. That is, with respect to a plurality of points on the water-repellent coating film surface present in a width of 12.7 cm (2.54 μm as an actual film width) in the photograph of the cross section of the water-repellent coating film, the distance from the side (lower side of the water-repellent coating film) on the substrate surface side of the water-repellent coating film to the water-repellent coating film surface was measured, and the average in this cross section was determined. The average value of the cross section was obtained with respect to 20 points of the cross sections of the water-repellent coating film prepared in the same manner as in the following porosity, and their averaged value was taken as the average thickness.

### 5. Porosity

With respect to photographs of cross sections formed by cutting a 7 cm square substrate provided with a water-repellent coating film in a thickness direction at positions every 1 cm in one direction, by a scanning electron microscope (S-4500 model, manufactured by Hitachi Ltd., measuring conditions: accelerating voltage of 15 kV and emission current of 5 μm) with 50,000 magnifications, the ratio (%) of the area of voids (the sum of closed voids present in the interior and concave voids open to the coating film upper side (surface) present in a size of at most the average thickness of the coating film when the cross section was projected at right angles, provided that when hollow metal oxide fine particles were used, internal voids in the hollow fine particles are not added in to voids of the film cross section) to the area when the cross section was projected at right angles was determined, cross sections at randomly selected 20 points from the cut cross sections were photographed, and the average of 20 points was taken as the porosity.

### 6. Water Contact Angle

2 μl of a water droplet of pure water ejected from the syringe tip was placed so as to be in contact with the surface of the water-repellent coating film, or if the water-repellency was so high that the water droplet would not be deposited on the film surface, the water droplet was dropped, and the contact angle of the water droplet was measured by means of a contact angle meter (CA-X150 model, manufactured by Kyowa Interface Science Co., Ltd.).

### 7. Water Splash Property

The substrate provided with a water-repellent coating film was replaced so that the water-repellent coating film surface (measurement surface) faced upward and that the measurement surface had a gradient of 45° relative to the horizontal plane, and to the measurement surface, 20 μl of a droplet of pure water was dropped with a falling height of 10 cm in a direction at right angles to the horizontal plane, and the distance of splash of the water which had fallen to the measurement surface of the substrate provided with a water-repellent coating film, in a direction in parallel with the substrate, was measured and regarded as the water splash property.

### 8. Measurement of Surface Concave-Convex Structure

### (1) Arithmetic Mean Roughness (Ra) and Maximum Peak-Valley Difference (P-V)

The surface shape of the water-repellent coating film was measured by means of a probe microscope (manufactured by Seiko Instruments Inc., SPA-400, Nanonavi Station). For the measurement, the observation mode of the probe microscope was dumping mode, and the scanning area was 10 μm. The arithmetic mean roughness (Ra) and the maximum peak-valley difference (P-V) were calculated by means of an exclusive software.

### 9. Haze Value

The haze value of the water-repellent substrate was measured in accordance with JIS K7015 by using a haze computer (model: S-SM-K224, manufactured by Suga Test Instruments Co., Ltd.).

### 10. Abrasion Test

Using a reciprocating traverse tester (manufactured by KNT), a flannel cloth in accordance with JIS L0803 was reciprocated 2,000 times on the surface of the water-repellent coating film of the water-repellent substrate by exerting a load of 11.8 N/4 cm² to abrade the surface of the water-repellent coating film. After 500 reciprocations, 1,000 reciprocations and 2,000 reciprocations, the water contact angle and the water splash property (after 500 reciprocations and 2,000 reciprocations) were evaluated by the above method.

### Example 1

As the composition for formation of undercoat layer, a liquid obtained by mixing 2-propanol (1.95 g), dispersion liquid (1) (1.43 g) of aggregates of alumina fine particles obtained in [2-1] and binder composition (1) (0.62 g) obtained in [1-1] was used. This composition for formation of undercoat layer, [4] composition for undercoat layer reinforcing treatment or [5] composition for undercoat layer reinforcing treatment, [6] composition for formation of adhesion layer and [7] composition for formation of water-repellent layer were applied and dried by the application/drying method [8] to form a water-repellent substrate sample (hereinafter referred to simply as “sample”) having a water-repellent coating film formed thereon. As [4] composition for undercoat layer reinforcing treatment, a liquid of a perhydropolysilazane at a concentration of 2 mass % (hereinafter the concentration of the composition for undercoat layer reinforcing treatment means the concentration of the perhydropolysilazane) was used.

The material components used for the above sample preparation are summarized in Table 1. In Table 1, the mass ratio of the aggregates of metal oxide fine particles (A) to the metal compound (B) to be a precursor for a metal oxide binder in the composition for formation of undercoat layer is shown. Further, in a case where aggregates of metal oxide fine particles (C) are contained, the mass ratio of the aggregates of metal oxide fine particles (A), aggregates of metal oxide fine particles (C) and the metal compound (B) to be a precursor for a metal oxide binder is shown. Further, the mass % of the aggregates of metal oxide fine particles (C) to the aggregates of metal oxide fine particles (A) is shown.

Likewise, material components used for sample preparation are shown in Table 1 with respect to Examples 2 to 20, in Table 2 with respect to Examples 21 to 31 and in Table 5 with respect to Examples 32 to 43.

Further, with respect to the water-repellent coating film of each of the obtained samples, the respective measurements and evaluations of 4. to 10. in the above [9] were carried out. The results are shown in Table 3. In the following respective Examples, the same measurements and evaluations were carried out unless otherwise specified. The results are shown in Table 3 with respect to Examples 1 to 20, in Table 4 with respect to Examples 21 to 31 and in Table 6 with respect to Examples 32 to 43.

### Example 2

A sample was obtained in the same manner as in Example 1 except that as the composition for formation of undercoat layer, a liquid obtained by mixing 2-propanol (1.95 g), dispersion liquid (2) (1.43 g) of aggregates of zirconia fine particles obtained in [2-2] and binder composition (1) (0.62 g) obtained in [1-1] was used.

### Example 3

A sample was obtained in the same manner as in Example 1 except that as the composition for formation of undercoat layer, a liquid obtained by mixing 2-propanol (1.95 g), dispersion liquid (3) (1.43 g) of aggregates of silica fine particles obtained in [2-3] and binder composition (1) (0.62 g) obtained in [1-1] was used.

### Example 4

A sample was obtained in the same manner as in Example 1 except that as the composition for formation of undercoat layer, a liquid obtained by mixing 2-propanol (2.7 g), dispersion liquid (4) (0.68 g) of aggregates of alumina hollow fine particles obtained in [2-4] and binder composition (1) (0.62 g) obtained in [1-1] was used.

### Example 5

A sample was obtained in the same manner as in Example 1 except that as the composition for formation of undercoat layer, a liquid obtained by mixing 2-propanol (2.93 g), dispersion liquid (5) (0.45 g) of aggregates of zirconia hollow fine particles obtained in [2-5] and binder composition (1) (0.62 g) obtained in [1-1] was used.

### Example 6

A sample was obtained in the same manner as in Example 1 except that as the composition for formation of undercoat layer, a liquid obtained by mixing 2-propanol (2.12 g), dispersion liquid (6) (1.44 g) of aggregates of hollow silica fine particles obtained in [2-6] and binder composition (1) (0.44 g) obtained in [1-1] was used, and that as [4] composition for undercoat layer reinforcing treatment, a liquid at a concentration of 1 mass % was used.

### Example 7

A sample was obtained in the same manner as in Example 6 except that as the composition for formation of undercoat layer, a liquid obtained by mixing 2-propanol (2.12 g), dispersion liquid (6) (1.40 g) of aggregates of hollow silica fine particles obtained in [2-6] and binder composition (1) (0.48 g) obtained in [1-1] was used.

### Example 8

A sample was obtained in the same manner as in Example 6 except that as the composition for formation of undercoat layer, a liquid obtained by mixing 2-propanol (2.14 g), dispersion liquid (6) (1.24 g) of aggregates of hollow silica fine particles obtained in [2-6] and binder composition (1) (0.62 g) obtained in [1-1] was used.

### Example 9

A sample was obtained in the same manner as in Example 6 except that as the composition for formation of undercoat layer, a liquid obtained by mixing 2-propanol (2.16 g), dispersion liquid (6) (0.96 g) of aggregates of hollow silica fine particles obtained in [2-6] and binder composition (1) (0.88 g) obtained in [1-1] was used.

### Example 10

A sample was obtained in the same manner as in Example 6 except that as the composition for formation of undercoat layer, a liquid obtained by mixing 2-propanol (2.07 g), dispersion liquid (6) (1.33 g) of aggregates of hollow silica fine particles obtained in [2-6], binder composition (1) (0.48 g) obtained in [1-1] and metal oxide fine particles (C) (a liquid having IPA-ST-S manufactured by Nissan Chemical Industries, Ltd. diluted with 2-propanol to a solid content of 2.5 mass %) (0.128 g) was used.

### Example 11

A sample was obtained in the same manner as in Example 6 except that as the composition for formation of undercoat layer, a liquid obtained by mixing 2-propanol (2.01 g), dispersion liquid (6) (1.26 g) of aggregates of hollow silica fine particles obtained in [2-6], binder composition (1) (0.48 g) obtained in [1-1] and metal oxide fine particles (C) (a liquid having IPA-ST-S manufactured by Nissan Chemical Industries, Ltd. diluted with 2-propanol to a solid content of 2.5 mass %) (0.256 g) was used.

### Example 12

As the composition for formation of undercoat layer, a liquid obtained by mixing 2-propanol (2.01 g), dispersion liquid (6) (1.26 g) of aggregates of hollow silica fine particles obtained in [2-6], binder composition (2) (0.48 g) obtained in [1-2] and metal oxide fine particles (C) (a liquid having IPA-ST-S manufactured by Nissan Chemical Industries, Ltd. diluted with 2-propanol to a solid content of 2.5 mass %) (0.256 g) was used. This composition for formation of undercoat layer and [7] composition for formation of water-repellent layer were applied and dried by [8] application/drying method to obtain a sample.

### Example 13

A sample was obtained in the same manner as in Example 11 except that [6] composition for formation of adhesion layer was not used.

### Example 14

A sample was obtained in the same manner as in Example 12 except that [6] composition for formation of undercoat layer was used.

### Example 15

A sample was obtained in the same manner as in Example 6 except that as the composition for formation of undercoat layer, a liquid obtained by mixing 2-propanol (1.89 g), dispersion liquid (6) (1.12 g) of aggregates of hollow silica fine particles obtained in [2-6], binder composition (1) (0.48 g) obtained in [1-1] and metal oxide fine particles (C) (a liquid having IPA-ST-S manufactured by Nissan Chemical Industries, Ltd. diluted with 2-propanol to a solid content of 2.5 mass %) (0.512 g) was used.

### Example 16

A sample was obtained in the same manner as in Example 6 except that as the composition for formation of undercoat layer, a liquid obtained by mixing 2-propanol (1.77 g), dispersion liquid (6) (0.98 g) of aggregates of hollow silica fine particles obtained in [2-6], binder composition (1) (0.48 g) obtained in [1-1] and metal oxide fine particles (C) (a liquid having IPA-ST-S manufactured by Nissan Chemical Industries, Ltd. diluted with 2-propanol to a solid content of 2.5 mass %) (0.768 g) was used.

### Example 17

A sample was obtained in the same manner as in Example 6 except that as the composition for formation of undercoat layer, a liquid obtained by mixing 2-propanol (1.54 g), dispersion liquid (6) (0.70 g) of aggregates of hollow silica fine particles obtained in [2-6], binder composition (1) (0.48 g) obtained in [1-1] and metal oxide fine particles (C) (a liquid having IPA-ST-S manufactured by Nissan Chemical Industries, Ltd. diluted with 2-propanol to a solid content of 2.5 mass %) (1.28 g) was used.

### Example 18

A sample was obtained in the same manner as in Example 11 except that as the metal oxide fine particles (C) in the composition for formation of undercoat layer, a liquid (0.256 g) having ST-OXS manufactured by Nissan Chemical Industries, Ltd. diluted with pure water to a solid content of 2.5 mass % was used.

### Example 19

A sample was obtained in the same manner as in Example 11 except that as the metal oxide fine particles (C) in the composition for formation of undercoat layer, a liquid (0.256 g) having IPA-ST manufactured by Nissan Chemical Industries, Ltd. diluted with 2-propanol to a solid content of 2.5 mass % was used.

### Example 20

A sample was obtained in the same manner as in Example 11 except that as the metal oxide fine particles (C) in the composition for formation of undercoat layer, ZSL-10T (solid content: 10 mass %) (0.176 g) manufactured by DAIICHI KIGENSO KAGAKU KOGYO CO., LTD. was used.

### Example 21

A sample was obtained in the same manner as in Example 7 except that as the composition for undercoat layer reinforcing treatment, a liquid at a concentration of 1.5 mass % was used.

### Example 22

A sample was obtained in the same manner as in Example 7 except that as the composition for undercoat layer reinforcing treatment, a liquid at a concentration of 2 mass % was used.

### Example 23

A sample was obtained in the same manner as in Example 11 except that as the composition for formation of adhesion layer, a liquid (4 g) having binder composition (2) prepared in [1-2] diluted five fold with 2-propanol was used.

### Example 24

A sample was obtained in the same manner as in Example 11 except that as the composition for formation of adhesion layer, a liquid (4 g) having tetrachlorosilane diluted with butyl acetate to 0.5 mass % was used.

### Example 25

A sample was obtained in the same manner as in Example 7 except that as the hollow silica in the composition for formation of undercoat layer, dispersion liquid (7) (1.40 g) of aggregates of hollow silica fine particles obtained in [2-7] was used.

### Example 26

A sample was obtained in the same manner as in Example 8 except that as the hollow silica in the composition for formation of undercoat layer, dispersion liquid (8) (1.24 g) of aggregates of hollow silica fine particles obtained in [2-8] was used.

### Example 27

A sample was obtained in the same manner as in Example 7 except that as the hollow silica in the composition for formation of undercoat layer, dispersion liquid (11) (1.40 g) of aggregates of hollow silica fine particles obtained in [2-11] was used.

### Example 28

A sample was obtained in the same manner as in Example 7 except that as the hollow silica in the composition for formation of undercoat layer, dispersion liquid (12) (1.40 g) of aggregates of hollow silica fine particles obtained in [2-12] was used.

### Example 29

A sample was obtained in the same manner as in Example 27 except that the amount of 2-propanol in the composition for formation of undercoat layer was 6.13 g.

### Example 30

A sample was obtained in the same manner as in Example 7 except that the amount of 2-propanol in the composition for formation of undercoat layer was 0.8 g.

### Example 31

A sample was obtained in the same manner as in Example 7 except that the amount of 2-propanol in the composition for formation of undercoat layer was 0.13 g.

### Example 32

A sample was obtained in the same manner as in Example 1 except that as the composition for formation of undercoat layer, a liquid obtained by mixing 2-propanol (2.12 g), dispersion liquid (6) (1.53 g) of aggregates of hollow silica fine particles obtained in [2-6] and binder composition (1) (0.352 g) obtained in [1-1] was used, and that as the composition for undercoat layer reinforcing treatment, a liquid at a concentration of 1 mass % was used.

### Example 33

A sample was obtained in the same manner as in Example 6 except that as the composition for formation of undercoat layer, a liquid obtained by mixing 2-propanol (2.18 g), dispersion liquid (6) (0.76 g) of aggregates of hollow silica fine particles obtained in [2-6] and binder composition (1) (1.06 g) obtained in [1-1] was used.

### Example 34

A sample was obtained in the same manner as in Example 6 except that as the composition for formation of undercoat layer, a liquid obtained by mixing 2-propanol (1.43 g), dispersion liquid (6) (0.56 g) of aggregates of hollow silica fine particles obtained in [2-6], binder composition (1) (0.48 g) obtained in [1-1] and metal oxide fine particles (C) (a liquid having IPA-ST-S manufactured by Nissan Chemical Industries, Ltd. diluted with 2-propanol to a solid content of 2.5 mass %) (1.54 g) was used.

### Example 35

A sample was obtained in the same manner as in Example 11 except that as the metal oxide fine particles (C) in the composition for formation of undercoat layer, a liquid (0.256 g) having IPA-ST-L manufactured by Nissan Chemical Industries, Ltd. diluted with 2-propanol to a solid content of 2.5 mass % was used.

### Example 36

A sample was obtained in the same manner as in Example 11 except that as the metal oxide fine particles (C) in the composition for formation of undercoat layer, ZSL-20N (solid content: 10 mass %) (0.176 g) manufactured by DAIICHI KIGENSO KAGAKU KOGYO CO., LTD. was used.

### Example 37

A sample was obtained in the same manner as in Example 7 except that as the composition for undercoat layer reinforcing treatment, a liquid (4 g) at a concentration of 0.75 mass % was used.

### Example 38

A sample was obtained in the same manner as in Example 7 except that as the composition for undercoat layer reinforcing treatment, a liquid (4 g) at a concentration of 3.0 mass % was used.

### Example 39

A sample was obtained in the same manner as in Example 8 except that as the hollow silica in the composition for formation of undercoat layer, dispersion liquid (9) (1.24 g) of aggregates of hollow silica fine particles obtained in [2-9] was used.

### Example 40

A sample was obtained in the same manner as in Example 7 except that as the hollow silica in the composition for formation of undercoat layer, dispersion liquid (10) (1.40 g) of aggregates of hollow silica fine particles obtained in [2-10] was used.

### Example 41

A sample was obtained in the same manner as in Example 7 except that as the hollow silica in the composition for formation of undercoat layer, dispersion liquid (13) (1.40 g) of aggregates of hollow silica fine particles obtained in [2-13] was used.

### Example 42

A sample was obtained in the same manner as in Example 27 except that the amount of 2-propanol in the composition for formation of undercoat layer was 14.13 g.

### Example 43

A sample was obtained in the same manner as in Example 31 except that the conditions of the spin coater at the time of undercoat layer coating were 400 rpm and 20 seconds.

The material components of the water-repellent coating film in Examples 1 to 31 (Examples of the present invention) are shown in Table 1 (Examples 1 to 20) and Table 2 (Examples 21 to 31), and the evaluation results are shown in Table 3 (Examples 1 to 20) and Table 4 (Examples 21 to 31). Further, the material components of the water-repellent coating film in Examples 32 to 43 (Comparative Examples) are shown in Table 5, and the evaluation results are shown in Table 6.

TABLE 1

| | | | | | Mass ratio of aggregates of | |
|---|---|---|---|---|---|---|
| | | | | | metal oxide fine particles (A) | |
| | Aggregates of metal oxide fine particles (A) | | | | to metal oxide (B) | |
| | | | Volume | | Aggregates | |
| | | Average | average | Average | of metal | |
| | | primary | aggregate | shell | oxide fine | Metal |
| | Structure/ | particle | particle | thickness/ | particles | compound |
| | Composition | size/nm | size/nm | nm | (A) | (B) |
| Ex. 1 | Solid alumina fine particles | 55 | 505 | — | 65 | 35 |
| Ex. 2 | Solid zirconia fine particles | 70 | 430 | — | 65 | 35 |
| Ex. 3 | Solid silica fine particles | 50 | 220 | — | 65 | 35 |
| Ex. 4 | Hollow alumina fine particles | 37 | 510 | 5.5 | 65 | 35 |
| Ex. 5 | Hollow zirconia fine particles | 37 | 420 | 5.5 | 65 | 35 |
| Ex. 6 | Hollow silica fine particles | 35 | 395 | 4.5 | 75 | 25 |
| Ex. 7 | Hollow silica fine particles | 35 | 395 | 4.5 | 73 | 27 |
| Ex. 8 | Hollow silica fine particles | 35 | 395 | 4.5 | 65 | 35 |
| Ex. 9 | Hollow silica fine particles | 35 | 395 | 4.5 | 50 | 50 |
| Ex. 10 | Hollow silica fine particles | 35 | 395 | 4.5 | 72 | 28 |
| Ex. 11 | Hollow silica fine particles | 35 | 395 | 4.5 | 71 | 29 |
| Ex. 12 | Hollow silica fine particles | 35 | 395 | 4.5 | 71 | 29 |
| Ex. 13 | Hollow silica fine particles | 35 | 395 | 4.5 | 71 | 29 |
| Ex. 14 | Hollow silica fine particles | 35 | 395 | 4.5 | 71 | 29 |
| Ex. 15 | Hollow silica fine particles | 35 | 395 | 4.5 | 68 | 32 |
| Ex. 16 | Hollow silica fine particles | 35 | 395 | 4.5 | 65 | 35 |
| Ex. 17 | Hollow silica fine particles | 35 | 395 | 4.5 | 57 | 43 |
| Ex. 18 | Hollow silica fine particles | 35 | 395 | 4.5 | 71 | 29 |
| Ex. 19 | Hollow silica fine particles | 35 | 395 | 4.5 | 71 | 29 |
| Ex. 20 | Hollow silica fine particles | 35 | 395 | 4.5 | 71 | 29 |

| | Aggregates of metal oxide fine particles (C) | | | | |
|---|---|---|---|---|---|
| | | | | | Addition amount based |
| | Metal oxide fine | | | Volume average | on aggregates of metal |
| | particles (C) | | Average primary | aggregate | oxide fine particles |
| | (tradename) | Component | particle size/nm | particle size/nm | (A)/mass % |
| Ex. 1 | Nil | — | — | — | — |
| Ex. 2 | Nil | — | — | — | — |
| Ex. 3 | Nil | — | — | — | — |
| Ex. 4 | Nil | — | — | — | — |
| Ex. 5 | Nil | — | — | — | — |
| Ex. 6 | Nil | — | — | — | — |
| Ex. 7 | Nil | — | — | — | — |
| Ex. 8 | Nil | — | — | — | — |
| Ex. 9 | Nil | — | — | — | — |
| Ex. 10 | IPA-ST-S | SiO₂ | 9 | 10 | 10 |
| Ex. 11 | IPA-ST-S | SiO₂ | 9 | 10 | 22 |
| Ex. 12 | IPA-ST-S | SiO₂ | 9 | 10 | 22 |
| Ex. 13 | IPA-ST-S | SiO₂ | 9 | 10 | 22 |
| Ex. 14 | IPA-ST-S | SiO₂ | 9 | 10 | 22 |
| Ex. 15 | IPA-ST-S | SiO₂ | 9 | 10 | 50 |
| Ex. 16 | IPA-ST-S | SiO₂ | 9 | 10 | 85 |
| Ex. 17 | IPA-ST-S | SiO₂ | 9 | 10 | 199 |
| Ex. 18 | ST OXS | SiO₂ | 5 | 6 | 22 |
| Ex. 19 | IPA-ST-S | SiO₂ | 15 | 14 | 22 |
| Ex. 20 | ZSL-10T | ZrO₂ | 12 | 23 | 61 |

| | Mass ratio of aggregates of metal oxide fine | | | | |
|---|---|---|---|---|---|
| | particles (A)/aggregates of metal oxide fine | | | | |
| | particles (C)/metal oxide (B) | | | Undercoat layer | |
| | Aggregates | Aggregates | | reinforcing treatment | |
| | of metal | of metal | Metal | (polysilazane | |
| | oxide fine | oxide fine | compound | concentration/ | Adhesion layer |
| | particles (A) | particles (C) | (B) | mass %) | (Adhesion-improving component) |
| Ex. 1 | 65 | — | 35 | Done (2%) | Present (isocyanatesilane) |
| Ex. 2 | 65 | — | 35 | Done (2%) | Present (isocyanatesilane) |
| Ex. 3 | 65 | — | 35 | Done (2%) | Present (isocyanatesilane) |
| Ex. 4 | 65 | — | 35 | Done (2%) | Present (isocyanatesilane) |
| Ex. 5 | 65 | — | 35 | Done (2%) | Present (isocyanatesilane) |
| Ex. 6 | 75 | — | 25 | Done (1%) | Present (isocyanatesilane) |
| Ex. 7 | 73 | — | 27 | Done (1%) | Present (isocyanatesilane) |
| Ex. 8 | 65 | — | 35 | Done (1%) | Present (isocyanatesilane) |
| Ex. 9 | 50 | — | 50 | Done (1%) | Present (isocyanatesilane) |
| Ex. 10 | 67 | 7 | 26 | Done (1%) | Present (isocyanatesilane) |
| Ex. 11 | 61 | 14 | 25 | Done (1%) | Present (isocyanatesilane) |
| Ex. 12 | 61 | 14 | 25 | Nil | Nil |
| Ex. 13 | 61 | 14 | 25 | Done (1%) | Nil |
| Ex. 14 | 61 | 14 | 25 | Nil | Present (isocyanatesilane) |
| Ex. 15 | 51 | 25 | 24 | Done (1%) | Present (isocyanatesilane) |
| Ex. 16 | 42 | 36 | 22 | Done (1%) | Present (isocyanatesilane) |
| Ex. 17 | 27 | 53 | 20 | Done (1%) | Present (isocyanatesilane) |
| Ex. 18 | 61 | 14 | 25 | Done (1%) | Present (isocyanatesilane) |
| Ex. 19 | 61 | 14 | 25 | Done (1%) | Present (isocyanatesilane) |
| Ex. 20 | 50 | 30 | 20 | Done (1%) | Present (isocyanatesilane) |

TABLE 2

| | | | | | Mass ratio of aggregates of | |
|---|---|---|---|---|---|---|
| | | | | | metal oxide fine particles (A) | |
| | Aggregates of metal oxide fine particles (A) | | | | to metal oxide (B) | |
| | | | Volume | | Aggregates | |
| | | Average | average | Average | of metal | |
| | | primary | aggregate | shell | oxide fine | Metal |
| | Structure/ | particle | particle | thickness/ | particles | compound |
| | Composition | size/nm | size/nm | nm | (A) | (B) |
| Ex. 21 | Hollow silica fine particles | 35 | 395 | 4.5 | 73 | 27 |
| Ex. 22 | Hollow silica fine particles | 35 | 395 | 4.5 | 73 | 27 |
| Ex. 23 | Hollow silica fine particles | 35 | 395 | 4.5 | 71 | 29 |
| Ex. 24 | Hollow silica fine particles | 35 | 395 | 4.5 | 71 | 29 |
| Ex. 25 | Hollow silica fine particles | 20 | 356 | 1.5 | 73 | 27 |
| Ex. 26 | Hollow silica fine particles | 75 | 420 | 7 | 65 | 35 |
| Ex. 27 | Hollow silica fine particles | 35 | 240 | 4.5 | 73 | 27 |
| Ex. 28 | Hollow silica fine particles | 35 | 580 | 4.5 | 73 | 27 |
| Ex. 29 | Hollow silica fine particles | 35 | 240 | 4.5 | 73 | 27 |
| Ex. 30 | Hollow silica fine particles | 35 | 395 | 4.5 | 73 | 27 |
| Ex. 31 | Hollow silica fine particles | 35 | 395 | 4.5 | 73 | 27 |

| | Aggregates of metal oxide fine particles (C) | | | | |
|---|---|---|---|---|---|
| | | | | | Addition amount based |
| | Metal oxide fine | | | Volume average | on aggregates of metal |
| | particles (C) | | Average primary | aggregate | oxide fine particles |
| | (tradename) | Component | particle size/nm | particle size/nm | (A)/mass % |
| Ex. 21 | Nil | — | — | — | — |
| Ex. 22 | Nil | — | — | — | — |
| Ex. 23 | IPA-ST-S | SiO₂ | 9 | 10 | 22 |
| Ex. 24 | IPA-ST-S | SiO₂ | 9 | 10 | 22 |
| Ex. 25 | Nil | — | — | — | — |
| Ex. 26 | Nil | — | — | — | — |
| Ex. 27 | Nil | — | — | — | — |
| Ex. 28 | Nil | — | — | — | — |
| Ex. 29 | Nil | — | — | — | — |
| Ex. 30 | Nil | — | — | — | — |
| Ex. 31 | Nil | — | — | — | — |

| | Mass ratio of aggregates of metal oxide fine | | | | |
|---|---|---|---|---|---|
| | particles (A)/aggregates of metal oxide fine | | | | |
| | particles (C)/metal oxide (B) | | | Undercoat layer | |
| | Aggregates | Aggregates | | reinforcing treatment | |
| | of metal | of metal | Metal | (polysilazane | |
| | oxide fine | oxide fine | compound | concentration/ | Adhesion layer |
| | particles (A) | particles (C) | (B) | mass %) | (Adhesion-improving component) |
| Ex. 21 | 73 | — | 27 | Done (1.5%) | Present (isocyanatesilane) |
| Ex. 22 | 73 | — | 27 | Done (2%) | Present (isocyanatesilane) |
| Ex. 23 | 61 | 14 | 25 | Done (1%) | Present (alkoxysilane) |
| Ex. 24 | 61 | 14 | 25 | Done (1%) | Present (chlorosilane) |
| Ex. 25 | 73 | — | 27 | Done (1%) | Present (isocyanatesilane) |
| Ex. 26 | 65 | — | 35 | Done (1%) | Present (isocyanatesilane) |
| Ex. 27 | 73 | — | 27 | Done (1%) | Present (isocyanatesilane) |
| Ex. 28 | 73 | — | 27 | Done (1%) | Present (isocyanatesilane) |
| Ex. 29 | 73 | — | 27 | Done (1%) | Present (isocyanatesilane) |
| Ex. 30 | 73 | — | 27 | Done (1%) | Present (isocyanatesilane) |
| Ex. 31 | 73 | — | 27 | Done (1%) | Present (isocyanatesilane) |

TABLE 3

| | | Initial properties of water-repellent coating film | | | | | | Properties of water-repellent coating film after abrasion test | | | | |
|---|---|---|---|---|---|---|---|---|---|---|---|---|
| | | | | | | Maximum | | Contact | Contact | Contact | Water | Water |
| | | | | | | peak- | Arithmetic | angle | angle | angle | splash | splash |
| | | | | Water | | valley | mean | after | after | after | property | property |
| | | Water | | splash | Average | difference | roughness | 500 | 1,000 | 2,000 | after 500 | after |
| | Porosity/ | contact | Haze/ | property/ | thickness/ | (P − V)/ | (Ra)/ | recipro- | recipro- | recipro- | recipro- | 2,000 |
| | % | angle/° | % | mm | nm | nm | nm | cations/° | cations/° | cations/° | cations/° | reciprocations/° |
| Ex. 1 | 26 | 152 | 9.5 | 150 | 255 | 443 | 38 | 130 | 129 | 127 | 60 | 40 |
| Ex. 2 | 25 | 150 | 10.3 | 150 | 250 | 403 | 35 | 128 | 127 | 127 | 55 | 30 |
| Ex. 3 | 22 | 156 | 5 | 160 | 230 | 435 | 37 | 128 | 127 | 126 | 50 | 30 |
| Ex. 4 | 23 | 154 | 5.6 | 155 | 215 | 361 | 30 | 130 | 129 | 128 | 60 | 35 |
| Ex. 5 | 21 | 155 | 5.4 | 150 | 235 | 380 | 31 | 130 | 129 | 129 | 55 | 35 |
| Ex. 6 | 30 | 155 | 1.9 | 170 | 220 | 298 | 29 | 129 | 128 | 124 | 50 | 20 |
| Ex. 7 | 26 | 154 | 2 | 165 | 215 | 336 | 30 | 128 | 127 | 127 | 45 | 40 |
| Ex. 8 | 22 | 155 | 2.7 | 165 | 200 | 311 | 27 | 130 | 129 | 129 | 55 | 50 |
| Ex. 9 | 17 | 145 | 4 | 140 | 170 | 250 | 22 | 128 | 127 | 127 | 50 | 45 |
| Ex. 10 | 25 | 155 | 2 | 170 | 215 | 331 | 30 | 129 | 129 | 128 | 55 | 45 |
| Ex. 11 | 19 | 157 | 2.3 | 175 | 220 | 347 | 32 | 133 | 132 | 132 | 115 | 60 |
| Ex. 12 | 23 | 155 | 1.6 | 165 | 210 | 314 | 28 | 131 | 129 | 129 | 55 | 45 |
| Ex. 13 | 23 | 150 | 1.9 | 150 | 230 | 297 | 28 | 131 | 130 | 130 | 100 | 50 |
| Ex. 14 | 21 | 154 | 1.7 | 160 | 215 | 306 | 30 | 130 | 130 | 130 | 105 | 50 |
| Ex. 15 | 18 | 155 | 2.5 | 170 | 205 | 324 | 28 | 132 | 133 | 133 | 120 | 60 |
| Ex. 16 | 12 | 150 | 2.8 | 150 | 200 | 278 | 25 | 133 | 131 | 132 | 110 | 50 |
| Ex. 17 | 8 | 142 | 3 | 130 | 185 | 267 | 19 | 130 | 129 | 130 | 70 | 40 |
| Ex. 18 | 18 | 152 | 2.3 | 155 | 200 | 302 | 27 | 132 | 133 | 132 | 105 | 55 |
| Ex. 19 | 23 | 155 | 2.2 | 160 | 190 | 415 | 27 | 133 | 133 | 133 | 110 | 45 |
| Ex. 20 | 20 | 150 | 2.9 | 150 | 200 | 356 | 26 | 131 | 131 | 132 | 80 | 45 |

In the case of the above (iv), the amount of the metal oxide other than silicon oxide contained in the hollow fine particles is preferably from 1.0 to 8.0 parts by mass, more preferably from 1.5 to 5.0 parts by mass, per 100 parts by mass of silicon oxide contained in the hollow fine particles.

TABLE 4

| | | Initial properties of water-repellent coating film | | | | | | Properties of water-repellent coating film after abrasion test | | | | |
|---|---|---|---|---|---|---|---|---|---|---|---|---|
| | | | | | | Maximum | | Contact | Contact | Contact | Water | Water |
| | | | | | | peak- | Arithmetic | angle | angle | angle | splash | splash |
| | | | | Water | | valley | mean | after | after | after | property | property |
| | | Water | | splash | Average | difference | roughness | 500 | 1,000 | 2,000 | after 500 | after |
| | Porosity/ | contact | Haze/ | property/ | thickness/ | (P − V)/ | (Ra)/ | recipro- | recipro- | recipro- | recipro- | 2,000 |
| | % | angle/° | % | mm | nm | nm | nm | cations/° | cations/° | cations/° | cations/° | reciprocations/° |
| Ex. 21 | 21 | 154 | 2.6 | 155 | 190 | 389 | 29 | 131 | 131 | 132 | 80 | 65 |
| Ex. 22 | 9 | 146 | 3.1 | 145 | 210 | 284 | 31 | 129 | 128 | 129 | 55 | 45 |
| Ex. 23 | 23 | 154 | 3.5 | 157 | 235 | 367 | 35 | 128 | 129 | 129 | 65 | 40 |
| Ex. 24 | 20 | 152 | 2.6 | 152 | 220 | 302 | 29 | 128 | 128 | 127 | 50 | 35 |
| Ex. 25 | 25 | 143 | 1.8 | 130 | 220 | 264 | 20 | 126 | 125 | 125 | 30 | 20 |
| Ex. 26 | 23 | 145 | 3.5 | 135 | 210 | 253 | 21 | 128 | 128 | 128 | 55 | 35 |
| Ex. 27 | 23 | 137 | 1.5 | 110 | 200 | 230 | 16 | 129 | 126 | 126 | 30 | 25 |
| Ex. 28 | 26 | 157 | 3.6 | 170 | 195 | 408 | 35 | 132 | 130 | 131 | 90 | 50 |
| Ex. 29 | 26 | 136 | 1 | 110 | 65 | 216 | 15 | 125 | 126 | 124 | 30 | 20 |
| Ex. 30 | 27 | 154 | 3.7 | 155 | 380 | 390 | 31 | 130 | 130 | 130 | 75 | 50 |
| Ex. 31 | 29 | 157 | 4.8 | 165 | 590 | 462 | 38 | 128 | 127 | 126 | 45 | 30 |

TABLE 5

| | | | | | Mass ratio of aggregates of | |
|---|---|---|---|---|---|---|
| | Aggregates of metal oxide fine particles (A) | | | | metal oxide fine particles (A) | |
| | | | Volume | | Aggregates | |
| | | Average | average | Average | of metal | |
| | | primary | aggregate | shell | oxide fine | Metal |
| | Structure/ | particle | particle | thickness/ | particles | compound |
| | Composition | size/nm | size/nm | nm | (A) | (B) |
| Ex. 32 | Hollow silica fine particles | 35 | 395 | 4.5 | 80 | 20 |
| Ex. 33 | Hollow silica fine particles | 35 | 395 | 4.5 | 40 | 60 |
| Ex. 34 | Hollow silica fine particles | 35 | 395 | 4.5 | 52 | 48 |
| Ex. 35 | Hollow silica fine particles | 35 | 395 | 4.5 | 72 | 28 |
| Ex. 36 | Hollow silica fine particles | 35 | 395 | 4.5 | 72 | 28 |
| Ex. 37 | Hollow silica fine particles | 35 | 395 | 4.5 | 78 | 27 |
| Ex. 38 | Hollow silica fine particles | 35 | 395 | 4.5 | 78 | 27 |
| Ex. 39 | Hollow silica fine particles | 90 | 410 | 8 | 65 | 35 |
| Ex. 40 | Hollow silica fine particles | 35 | 170 | 4.5 | 73 | 27 |
| Ex. 41 | Hollow silica fine particles | 35 | 720 | 4.5 | 73 | 27 |
| Ex. 42 | Hollow silica fine particles | 35 | 240 | 4.5 | 73 | 27 |
| Ex. 43 | Hollow silica fine particles | 35 | 395 | 4.5 | 73 | 27 |

| | Aggregates of metal oxide fine particles (C) | | | | |
|---|---|---|---|---|---|
| | | | | | Addition amount based |
| | Metal oxide fine | | | Volume average | on aggregates of metal |
| | particles (C) | | Average primary | aggregate | oxide fine particles |
| | (tradename) | Component | particle size/nm | particle size/nm | (A)/mass % |
| Ex. 32 | Nil | — | — | — | — |
| Ex. 33 | Nil | — | — | — | — |
| Ex. 34 | IPA-ST-S | SiO₂ | 9 | 10 | 299 |
| Ex. 35 | IPA-ST-L | SiO₂ | 45 | 43 | 21 |
| Ex. 36 | ZSL-20N | ZrO₂ | 70 | 72 | 58 |
| Ex. 37 | Nil | — | — | — | — |
| Ex. 38 | Nil | — | — | — | — |
| Ex. 39 | Nil | — | — | — | — |
| Ex. 40 | Nil | — | — | — | — |
| Ex. 41 | Nil | — | — | — | — |
| Ex. 42 | Nil | — | — | — | — |
| Ex. 43 | Nil | | — | — | — |

| | Mass ratio of aggregates of metal oxide fine | | | | |
|---|---|---|---|---|---|
| | particles (A)/aggregates of metal oxide fine | | | | |
| | particles (C)/metal oxide (B) | | | Undercoat layer | |
| | Aggregates | Aggregates | | reinforcing treatment | |
| | of metal | of metal | Metal | (polysilazane | |
| | oxide fine | oxide fine | compound | concentration/ | Adhesion layer |
| | particles (A) | particles (C) | (B) | mass %) | (Adhesion-improving component) |
| Ex. 32 | 80 | — | 20 | Done (1%) | Present (isocyanatesilane) |
| Ex. 33 | 40 | — | 60 | Done (1%) | Present (isocyanatesilane) |
| Ex. 34 | 20 | 61 | 19 | Done (1%) | Present (isocyanatesilane) |
| Ex. 35 | 62 | 13 | 25 | Done (1%) | Present (isocyanatesilane) |
| Ex. 36 | 51 | 29 | 20 | Done (1%) | Present (isocyanatesilane) |
| Ex. 37 | 78 | — | 27 | Done (0.75%) | Present (isocyanatesilane) |
| Ex. 38 | 78 | — | 27 | Done (3%) | Present (isocyanatesilane) |
| Ex. 39 | 65 | — | 35 | Done (1%) | Present (isocyanatesilane) |
| Ex. 40 | 73 | — | 27 | Done (1%) | Present (isocyanatesilane) |
| Ex. 41 | 73 | — | 27 | Done (1%) | Present (isocyanatesilane) |
| Ex. 42 | 73 | — | 27 | Done (1%) | Present (isocyanatesilane) |
| Ex. 43 | 73 | — | 27 | Done (1%) | Present (isocyanatesilane) |

TABLE 6

| | | | | | | | | Properties of water-repellent coating film after | | | | |
|---|---|---|---|---|---|---|---|---|---|---|---|---|
| | | Initial properties of water-repellent coating film | | | | | | abrasion resistent test | | | | |
| | | | | | | Maximum | | Contact | Contact | Contact | Water | Water |
| | | | | | | peak- | Arithmetic | angle | angle | angle | splash | splash |
| | | | | Water | | valley | mean | after | after | after | property | property |
| | | Water | | splash | Average | difference | roughness | 500 | 1,000 | 2,000 | after 500 | after |
| | Porosity/ | contact | Haze/ | property/ | thickness/ | (P − V)/ | (Ra)/ | recipro- | recipro- | recipro- | recipro- | 2,000 |
| | % | angle/° | % | mm | nm | nm | nm | cations/° | cations/° | cations/° | cations/° | reciprocations/° |
| Ex. 32 | 42 | 152 | 1.7 | 150 | 250 | 276 | 25 | 103 | 81 | 70 | 0 | 0 |
| | | | | | | | | (scars) | (scars) | (scars) | | |
| Ex. 33 | 9 | 131 | 4.8 | 95 | 155 | 181 | 14 | 125 | 122 | 120 | 5 | 0 |
| Ex. 34 | 5 | 129 | 2.7 | 90 | 175 | 178 | 14 | 120 | 121 | 120 | 0 | 0 |
| Ex. 35 | 35 | 155 | 2 | 160 | 195 | 289 | 29 | 124 | 118 | 105 | 0 | 0 |
| | | | | | | | | | | (scars) | | |
| Ex. 36 | 38 | 156 | 2.2 | 165 | 215 | 321 | 31 | 123 | 110 | 89 | 0 | 0 |
| | | | | | | | | | | (scars) | | |
| Ex. 37 | 35 | 152 | 1.5 | 160 | 225 | 350 | 35 | 123 | 111 | 105 | 0 | 0 |
| | | | | | | | | | | (scars) | | |
| Ex. 38 | 5 | 115 | 2.5 | 0 | 230 | 132 | 12 | 112 | 110 | 110 | 0 | 0 |
| Ex. 39 | 26 | 131 | 10.3 | 90 | 205 | 139 | 13 | 120 | 115 | 115 | 0 | 0 |
| Ex. 40 | 20 | 115 | 0.5 | 0 | 200 | 129 | 11 | 110 | 108 | 108 | 0 | 0 |
| Ex. 41 | 35 | 160 | 8.3 | 180 | 210 | 481 | 40 | 122 | 120 | 117 | 5 | 0 |
| Ex. 42 | 25 | 114 | 0.3 | 0 | 45 | 122 | 10 | 110 | 105 | 103 | 0 | 0 |
| Ex. 43 | 34 | 161 | 6.4 | 180 | 650 | 495 | 43 | 122 | 120 | 119 | 5 | 0 |

As evident from Tables 3, 4 and 6, the water-repellent substrate (Examples 1 to 31) of the present invention are excellent in the water-repellency and the abrasion resistance of the water-repellent coating film formed on the surface as compared with the water-repellent substrates of Comparative Examples (Examples 32 to 43). Specifically, the water-repellent substrates (Examples 1 to 31) of the present invention have initial water-repellent performance and water repellence performance after the abrasion resistance test above a certain level with respect to the water-repellency evaluated by the water splash property.

### INDUSTRIAL APPLICABILITY

The water-repellent substrate having a water-repellent coating film of the present invention, the water-repellent coating film surface of which is excellent in the water-repellency and the abrasion resistance, is useful for an article for a transport machine (such as an automobile, a train, a ship or an airplane), particularly for a window glass. This application is a continuation of PCT Application No. PCT/JP2011/050777, filed on Jan. 18, 2011, which is based upon and claims the benefit of priority from Japanese Patent Application No. 2010-008738 filed on Jan. 19, 2010. The contents of those applications are incorporated herein by reference in its entirety.

### REFERENCE SYMBOLS

1: substrate, 2: water-repellent coating film, 3: pure water, 4: dropping means, 5: dropping point, 6: position where pure water dropped to measurement stand, 8: measurement stand, 10: water-repellent substrate (specimen), 11: undercoat layer, 12: water-repellent layer, a1, a2, a3 and a4: internal closed void, b1, b2: concave void open to coating film upper side (surface) present in a size of at most average thickness of coating film when cross section is projected at right angles.

What is claimed is:

1. A water-repellent substrate having a water-repellent coating film on at least one side of a substrate, wherein:
the water-repellent coating film comprises an undercoat layer which comprises aggregates of metal oxide fine particles (A) having an average primary particle size of from 20 to 85 nm and a metal oxide binder, and which has a concave-convex surface, formed on the substrate side, and a water-repellent layer formed on the undercoat layer; and
the water splash property of the surface of the water-repellent coating film as evaluated by the following method is at least 100 mm, and the water splash property of the surface of the water-repellent coating film is at least 20 mm after an abrasion test for 2,000 reciprocations by means of a traverse tester at a stress of 11.8 N/4 cm² using a flannel cloth in accordance with JIS L0803:
water splash property: the water-repellent substrate is placed so that the surface (hereinafter referred to as the measurement surface) having the water-repellent coating film of the substrate faces upward, and that the measurement surface has a gradient of 45° relative to the horizontal plane, 20 μl of a droplet of pure water is dropped from a height of 10 cm from the measurement surface, to the measurement surface, and a distance of splash of the water which has fallen to the measurement surface, in a direction in parallel with the measurement surface, is measured and regarded as the water splash property.

2. A water-repellent substrate having a water-repellent coating film on at least one side of a substrate, wherein:
the water-repellent coating film comprises an undercoat layer which comprises aggregates of metal oxide fine particles (A) having an average primary particle size of from 20 to 85 nm and a metal oxide binder, and which has a concave-convex surface, formed on the substrate side, and a water-repellent layer formed on the undercoat layer; and
the water splash property of the surface of the water-repellent coating film as evaluated by the following method is at least 100 mm, and the following porosity of the water-repellent coating film is at most 30%:
water splash property: the water-repellent substrate is placed so that the surface (hereinafter referred to as the measurement surface) having the water-repellent coating film of the substrate faces upward, and that the measurement surface has a gradient of 45° relative to the horizontal plane, 20 μl of a droplet of pure water is dropped from a height of 10 cm from the measurement surface, to the measurement surface, and a distance of splash of the water which has fallen to the measurement surface, in a direction in parallel with the measurement surface, is measured and regarded as the water splash property;
porosity: the ratio (%) of the area of voids in the cross section of the water-repellent coating film.

3. The water-repellent substrate according to claim 1, wherein when the mass of the aggregates of the metal oxide fine particles (A) is (a) and the mass of the metal oxide binder is (b), their mass ratio (a):(b) is from 75:25 to 50:50, as calculated as metal oxides.

4. The water-repellent substrate according to claim 1, wherein the arithmetic mean roughness (Ra) of the surface of the water-repellent coating film is from 15 nm to 40 nm as measured by a scanning probe microscope (SPM) in accordance with JIS R1683 (2007).

5. The water-repellent substrate according to claim 1, wherein the metal oxide fine particles (A) are hollow silica fine particles.

6. The water-repellent substrate according to claim 1, wherein the undercoat layer further contains aggregates of metal oxide fine particles (C) having an average primary particle size of from 3 to 18 nm.

7. The water-repellent substrate according to claim 1, wherein the average thickness of the water-repellent coating film is from 50 to 600 nm.

8. A water-repellent substrate having a water-repellent coating film on at least one side of a substrate, wherein:
the water-repellent coating film comprises an undercoat layer which is obtained by applying a composition for formation of undercoat layer containing aggregates of metal oxide fine particles (A) having an average primary particle size of from 20 to 85 nm and a metal oxide binder precursor, followed by drying, and which has a concave-convex surface, and a water-repellent layer formed on the undercoat layer; and
the water splash property of the surface of the water-repellent coating film as evaluated by the following method is at least 100 mm, and the water splash property of the surface of the water-repellent coating film is at least 20 mm after an abrasion test for 2,000 reciprocations by means of a traverse tester at a stress of 11.8 N/4 cm² using a flannel cloth in accordance with JIS L0803:
water splash property: the water-repellent substrate is placed so that the surface (hereinafter referred to as the measurement surface) having the water-repellent coating film of the substrate faces upward, and that the measurement surface has a gradient of 45° relative to the horizontal plane, 20 μl of a droplet of pure water is dropped from a height of 10 cm from the measurement surface, to the measurement surface, and a distance of splash of the water which has fallen to the measurement surface, in a direction in parallel with the measurement surface, is measured and regarded as the water splash property.

9. A water-repellent substrate having a water-repellent coating film on at least one side of a substrate, wherein:
the water-repellent coating film comprises an undercoat layer which is obtained by applying a composition for formation of undercoat layer containing aggregates of metal oxide fine particles (A) having an average primary particle size of from 20 to 85 nm and a metal oxide binder precursor, followed by drying, and which has a concave-convex surface, and a water-repellent layer formed on the undercoat layer; and
the water splash property of the surface of the water-repellent coating film as evaluated by the following method is at least 100 mm, and the following porosity of the water-repellent coating film is at most 30%:
water splash property: the water-repellent substrate is placed so that the surface (hereinafter referred to as the measurement surface) having the water-repellent coating film of the substrate faces upward, and that the measurement surface has a gradient of 45° relative to the horizontal plane, 20 μl of a droplet of pure water is dropped from a height of 10 cm from the measurement surface, to the measurement surface, and a distance of splash of the water which has fallen to the measurement surface, in a direction in parallel with the measurement surface, is measured and regarded as the water splash property;
porosity: the ratio (%) of the area of voids in the cross section of the water-repellent coating film.

10. An article for a transport machine comprising the water-repellent substrate as defined in claim 1.

11. A window glass for a transport machine, which is the water-repellent substrate as defined in claim 1, wherein the substrate is a glass plate.

12. A process for producing a water-repellent substrate having a water-repellent coating film comprising an undercoat layer and a water-repellent layer, on at least one side of a substrate, which comprises:
a step of applying, on at least one side of the substrate, a composition for formation of undercoat layer containing aggregates of metal oxide fine particles, a metal oxide binder precursor and a dispersing medium;
the aggregates of the metal oxide fine particles mainly consisting of aggregates of metal oxide fine particles (A) having an average primary particle size of from 20 to 85 nm and a volume average aggregate particle size of from 200 to 600 nm, and the composition for formation of undercoat layer containing the aggregates of the metal oxide fine particles (A) and the metal oxide binder precursor in a mass ratio of from 75:25 to 50:50 as calculated as metal oxides, or
the aggregates of the metal oxide fine particles mainly consisting of aggregates of the above metal oxide fine particles (A) and aggregates of metal oxide fine particles (C) having an average primary particle size of from 3 to 18 nm and a volume average aggregate particle size of from 3 to 30 nm in an amount of from 5 to 200 mass % of the content of the aggregates of the metal oxide fine particles (A), and the composition for formation of undercoat layer containing the aggregates of the metal oxide fine particles (A) and the metal oxide binder precursor in a mass ratio of from 75:25 to 50:50 as calculated as metal oxides, and the aggregates of the metal oxide fine particles and the metal oxide binder precursor in a mass ratio of from 90:10 to 50:50 as calculated as metal oxides;
followed by drying to form an undercoat layer which has a concave-convex surface; and
a step of applying a composition for formation of water-repellent layer containing a water-repellent agent on the surface of the undercoat layer, followed by drying to form a water-repellent layer on the surface of the undercoat layer thereby to form a water-repellent coating film having an average thickness of from 50 to 600 nm.

13. The process for producing a water-repellent substrate according to claim 12, wherein the mass ratio of the aggregates of the metal oxide fine particles (A) to the meal oxide binder precursor is from 72:28 to 60:40 as calculated as metal oxides.

14. The process for producing a water-repellent substrate according to claim 12, wherein the metal compound to be the metal oxide binder precursor is an alkoxysilane compound and/or a hydrolyzed condensate thereof.

15. The process for producing a water-repellent substrate according to claim 12, wherein the metal oxide fine particles (A) are silica fine particles.

16. The process for producing a water-repellent substrate according to claim 12, wherein the average primary particle size of the metal oxide fine particles (A) is from 20 to 75 nm.

17. The process for producing a water-repellent substrate according to claim 12, wherein the metal oxide fine particles (A) are hollow metal oxide fine particles.

18. The process for producing a water-repellent substrate according to claim 17, wherein the average shell thickness of the hollow metal oxide fine particles (A) is from 1 to 10 nm.

19. The process for producing a water-repellent substrate according to claim 12, wherein the metal oxide fine particles (C) are silica fine particles and/or zirconia fine particles.

20. The process for producing a water-repellent substrate according to claim 12, which further comprises, after the step for forming the undercoat layer, a step of impregnation with a polysilazane, followed by hydrolytic condensation or pyrolysis.

21. The process for producing a water-repellent substrate according to claim 12, which further comprises, after the step for forming the undercoat layer, a step of applying a composition for formation of adhesion layer containing, as the main material component, at least one member selected from the group consisting of alkoxysilanes, chlorosilanes and isocyanatesilanes, and/or a partially hydrolyzed condensate thereof, on the surface of the undercoat layer to form an adhesion layer.

22. The process for producing a water-repellent substrate according to claim 12, wherein the water splash property of the surface of the water-repellent coating film as evaluated by the following method is at least 100 mm, and the water splash property of the surface of the water-repellent coating film is at least 20 mm after an abrasion test for 2,000 reciprocations by means of a traverse tester at a stress of 11.8 N/4 cm² using a flannel cloth in accordance with JIS L0803:
water splash property: the water-repellent substrate is placed so that the surface (hereinafter referred to as the measurement surface) having the water-repellent coating film of the substrate faces upward, and that the measurement surface has a gradient of 45° relative to the horizontal plane, 20 μl of a droplet of pure water is dropped from a height of 10 cm from the measurement surface, to the measurement surface, and a distance of splash of the water which has fallen to the measurement surface, in a direction in parallel with the measurement surface, is measured and regarded as the water splash property.

23. The process for producing a water-repellent substrate according to claim 12, wherein the water splash property of the surface of the water-repellent coating film as evaluated by the following method is at least 100 mm, and the following porosity of the water-repellent coating film is at most 30%:
water splash property: the water-repellent substrate is placed so that the surface (hereinafter referred to as the measurement surface) having the water-repellent coating film of the substrate faces upward, and that the measurement surface has a gradient of 45° relative to the horizontal plane, 20 μl of a droplet of pure water is dropped from a height of 10 cm from the measurement surface, to the measurement surface, and a distance of splash of the water which has fallen to the measurement surface, in a direction in parallel with the measurement surface, is measured and regarded as the water splash property;
porosity: the ratio (%) of the area of voids in the cross section of the water-repellent coating film.

24. A composition for formation of undercoat layer, to be used for the process for producing a water-repellent substrate as defined in claim 12, which contains a dispersing medium and contains aggregates of metal oxide fine particles (A) having an average primary particle size of from 20 to 85 nm and a volume average aggregate particle size of from 200 to 600 nm, and a metal oxide binder precursor, in a mass ratio of from 75:25 to 50:50 as calculated as metal oxides.
